(19) United States
(12) Patent Application Publication
(10) Pub. No.: US 2017/0155831 A1
(43) Pub. Date: Jun. 1, 2017

(54) METHOD AND ELECTRONIC APPARATUS FOR PROVIDING VIDEO CALL

(71) Applicant: SAMSUNG ELECTRONICS CO., LTD., Suwon-si (KR)

(72) Inventors: Sung-hyun JANG, Seoul (KR); Sung-hye LEE, Seoul (KR); Seong-wook JEONG, Seoul (KR); Kwan-min LEE, Seoul (KR); Sang-hee LEE, Seoul (KR)

(73) Assignee: SAMSUNG ELECTRONICS CO., LTD., Suwon-si (KR)

(21) Appl. No.: 15/365,233

(22) Filed: Nov. 30, 2016

(30) Foreign Application Priority Data
Dec. 1, 2015 (KR) 10-2015-0169762

(51) Int. Cl. H04N 5/232; G06K 9/00; G10L 25/57; H04N 7/14

(52) U.S. Cl. CPC H04N 5/23219; H04N 7/141; H04N 5/23293; G06K 9/00228; H04N 5/23296; H04N 5/23245; G10L 25/57

(57) ABSTRACT

A method and an electronic apparatus for providing a video call are provided. The electronic apparatus includes a communicator configured to perform a video call, a photographing unit configured to capture a front, a display configured to display an image captured by the photographing unit, and a processor configured to, in response to a designated user command being input while performing a video call, detect at least one person included in the image captured by the photographing unit, control the photographing unit to track and capture the detected person, and control the display to track and display the captured person.

### CROSS-REFERENCE TO RELATED APPLICATIONS

This application claims priority from Korean Patent Application No. 10-2015-0169762, filed on Dec 1, 2015, in the Korean Intellectual Property Office, the disclosure of which is incorporated herein by reference in its entirety.

### BACKGROUND

Field

Apparatuses and methods consistent with the present disclosure relate to an electronic apparatus for providing a video call, and more particularly, to a method and an electronic apparatus for recognizing a user who is making a video call to automatically rotate a display and a camera.

Description of the Related Art

A display and a camera are fixed in a general electronic apparatus, which provides a video call, in a video call mode. Also, the general electronic apparatus that provides the video call does not provide an additional method of changing a capturing angle of the camera of the electronic apparatus and an output image angle of the display in the video call mode.

Therefore, if a user wants to change a capturing image angle of an existing electronic apparatus in a video call mode, the user inconveniently directly moves a display or a camera of the existing electronic apparatus. Also, since the camera of the existing electronic apparatus does not move in the video call mode, it is difficult for the user to stray from a capturing range of the existing electronic apparatus.

According to a related art, if the user wants to move a position of the user in the video call mode, the user is to return to a capturing position after directly moving to the existing electronic apparatus and then adjusting a capturing angle. Therefore, there is a need for an electronic apparatus that enables a user to adjust a camera angle of the electronic apparatus capturing the user and to automatically adjust an angle of a display that the user looks at if the user wants to change a capturing position in a video call mode.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides a method and an electronic apparatus for automatically rotating a camera and a display toward a user through a user recognition in a video call mode so as to improve immersion and convenience of a video call.

According to an aspect of the present disclosure, an electronic apparatus providing a video call, includes a communicator configured to perform a video call, a photographing unit configured to capture a front, a display configured to display an image captured by the photographing unit, and a processor configured to, in response to a designated user command being input while performing a video call, detect at least one person included in the image captured by the photographing unit, control the photographing unit to track and capture the detected person, and control the display to track and display the detected person.

The processor may detect a person closest to the electronic apparatus among the at least one person included in the image captured by the photographing unit and control the photographing unit to track and capture the closest person.

The processor may control the photographing unit to pause the tracking in response to the detected person straying from a designated capturing range and return to an initial capturing position in response to the detected person straying from the designated capturing range for a designated time.

In response to a voice or a motion of a user who indicates a particular direction being input during the video call, the processor may control the photographing unit to rotate in the particular direction.

The communicator may perform communication with at least one peripheral terminal apparatus while performing the video call. In response to a person being detected by the peripheral terminal apparatus as straying from a capturing range of the electronic apparatus and entering into a capturing range of the peripheral terminal apparatus, the processor may receive an event signal indicating that the person is detected, from the peripheral terminal apparatus and control the communicator to transmit image data received from an counterpart terminal while performing the video call, to the peripheral terminal apparatus in response to the event signal.

The processor may control the display to display an image received from an counterpart terminal while performing a video call and, in response to one of at least one person included in an image received from the counterpart terminal, control the communicator to transmit a signal requesting a photographing unit of the counterpart terminal to track the selected person to the counterpart terminal.

The processor may control the display to display an image received an counterpart terminal while performing a video call, in response to a user command for entering into a mode for remotely controlling the counterpart terminal being input, control the communicator to transmit a remote control request signal to the counterpart terminal, and in response to a remote control acceptance signal being received from the counterpart terminal in response to the remote control request signal, control the display to display a User Interface (UI) for controlling the counterpart terminal.

The processor may control the display to display an image received from an counterpart terminal while performing a video call and, in response to a name of one of at least one person included in the image received from the counterpart terminal being uttered by a user, control the communicator to transmit a signal which requests a photographing unit of the counterpart terminal to track the uttered person, and utterance information to the counterpart terminal.

The processor may control the photographing unit to recognize a voice of the user who performs the uttering so as to track and capture the user.

In response to a user command for entering into a content share mode being input, the communicator may perform communication so as to share a video content with a counterpart terminal while performing the video call. In response to a user command for a full screen view being input, the processor may control the display to automatically display a full screen according to a screen ratio at which the video content is played and, in response to the designated user command being input, control the display to automatically rotate and display the video content according to a position of the user.

According to another aspect of the present disclosure, a video call method may include performing communication for a video call, capturing a front through a camera, displaying the captured image, in response to a designated user command being input while performing a video call, detecting at least one person included in the captured image, and tracking and capturing the detected person, and tracking and displaying the detected person.

The tracking and capturing may include detecting a person closest to the camera among at least one person included in the image captured by the camera, and tracking and capturing the closest person.

The tracking and capturing may include pausing the tracking in response to the detected person straying from a designated capturing range and enabling the camera to return to an initial capturing position in response to the detected person straying from the designated capturing range for a designated time.

The tracking and capturing may include, in response to a voice or a motion of the user who indicates a particular direction being input during the video call, rotating the camera in the particular direction and then performing capturing.

The performing of the communication may include performing communication with at least one peripheral terminal apparatus while performing the video call. The tracking and capturing may include, in response to a person being detected by the peripheral terminal apparatus as straying from a capturing range of the electronic apparatus and entering into a capturing range of the peripheral terminal apparatus, receiving an event signal indicating that the person is detected, from the peripheral terminal apparatus and transmitting video data received from the counterpart terminal while performing the video call, to the peripheral terminal apparatus in response to the event signal.

The displaying may include displaying an image received from a counterpart terminal while performing a video call. The tracking and capturing may include, in response to one of at least one person included in the image received from the counterpart terminal, transmitting a signal which requests a camera of the counterpart terminal to track the selected person to the counterpart terminal.

The tracking and capturing may include, in response to a user command for entering into a mode for remotely controlling the counterpart terminal, transmitting a remote control request signal to the counterpart terminal. The displaying may include displaying an image received from a counterpart terminal while performing a video call and, in response to a remote control acceptance signal being received from the counterpart terminal in response to the remote control request signal, displaying an UI for controlling the counterpart terminal.

The displaying may include displaying an image received from a counterpart terminal while performing a video call. The tracking and capturing may include, in response to a name of one of at least one person included in an image received from the counterpart terminal being uttered by the user, enabling a camera of the counterpart terminal to track and capture the uttered person.

The tracking and capturing may include enabling the camera to recognize a voice of the uttered user so as to track and capture the user.

The performing of the communication may include, in response to a user command for entering into a content share mode being input, performing communication so as to enable a user to share a video content with a counterpart terminal while performing the video call. The tracking and displaying may include, in response to a user command for a full screen view being input, automatically displaying the video content on a full screen according to a screen ratio at which the video content is played and, in response to the designated user command being input, automatically rotating and displaying the video call according to a position of the user.

As described above, an electronic apparatus according to exemplary embodiments of the present disclosure may enable a user to use a video call with freely moving so as to enable the user to make the video call without restrictions on an environment and a position. Also, a camera and a display of the electronic apparatus may track the user and rotate together so as to enable the electronic apparatus to provide a more realistic video call method.

Additional and/or other aspects and advantages of the disclosure will be set forth in part in the description which follows and, in part, will be obvious from the description, or may be learned by practice of the disclosure.

### BRIEF DESCRIPTION OF THE DRAWING FIGURES

The above and/or other aspects of the present disclosure will be more apparent by describing certain exemplary embodiments of the present disclosure with reference to the accompanying drawings, in which:

FIG. 1 is a view illustrating an electronic apparatus that provides a video call in a tracking and capturing mode according to an exemplary embodiment of the present disclosure;

FIG. 2 is a block diagram of a simple configuration of an electronic apparatus according to an exemplary embodiment of the present disclosure;

FIG. 3 is a block diagram of a detailed configuration of an electronic apparatus according to an exemplary embodiment of the present disclosure;

FIG. 4 is a view illustrating tracking and capturing a person closest to an electronic apparatus in a video call mode according to an exemplary embodiment of the present disclosure;

FIG. 5 is a view illustrating tracking and capturing of an electronic apparatus if a user strays from a designated capturing range of the electronic apparatus in a video call mode according to an exemplary embodiment of the present disclosure;

FIG. 6 is a view illustrating tracking and capturing a user based on a voice recognition and a motion recognition of the user in a video call mode according to an exemplary embodiment of the present disclosure;

FIG. 7 is a view illustrating an electronic apparatus that changes a video call to a peripheral terminal apparatus in a video call mode according to an exemplary embodiment of the present disclosure;

FIGS. 8A and 8B are views illustrating selecting, tracking, and capturing a particular person included in an image transmitted from an counterpart terminal in a video call mode according to an exemplary embodiment of the present disclosure;

FIG. 9 is a view illustrating remotely controlling a photographing unit of an counterpart terminal in a video call mode according to an exemplary embodiment of the present disclosure;

FIG. 10 is a sequence diagram illustrating remotely controlling a photographing unit of an counterpart terminal in a video call mode according to an exemplary embodiment of the present disclosure;

FIGS. 11A through 11C are views illustrating sharing a content of a user with an counterpart terminal in a video call mode according to an exemplary embodiment of the present disclosure;

FIG. 12 is a view illustrating a video call for automatically tracking and capturing a user by a sensor on a home network according to another exemplary embodiment of the present disclosure; and

FIG. 13 is a flowchart of a method of performing tracking and capturing in a video call mode according to an exemplary embodiment of the present disclosure.

### DETAILED DESCRIPTION OF THE EXEMPLARY EMBODIMENTS

The terms used herein will be described in brief, and the present disclosure will be described in detail.

The terms used herein are selected as general terms that are currently widely used in consideration of their functions in the present disclosure. However, this may depend on intentions of those skilled in the art, precedents, emergences of new technologies, or the like. Also, an applicant may arbitrarily select terms in a particular case, and detailed meanings of the terms will be described in description parts of exemplary embodiments corresponding to the particular case. Therefore, the terms used herein may be defined based on meanings of the terms and whole contents of the exemplary embodiments not on simple names of the terms.

Exemplary embodiments of the present disclosure may be made into various modifications and may have several types of exemplary embodiments, and thus particular exemplary embodiments will be illustrated in the drawings and will be described in detail in the detailed description. However, this does not intend to limit a scope of a particular exemplary embodiment and may be understood as including all modifications, equivalents, and alternatives included in a disclosed spirit and a technical range In descriptions of exemplary embodiments, if detailed descriptions of associated well-known arts are determined as blurring the essentials of the present disclosure, the detailed descriptions will be omitted.

Although the terms, ‘first’, ‘second’, etc. may be used herein to describe various elements, these elements may not be limited by these terms. These terms are only used to distinguish one element from another.

The singular expression also includes the plural meaning as long as it does not differently mean in the context. In the present application, the terms “include”, “comprise”, and the like designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

In the present disclosure, when any part is “connected” to another part, this includes a “direct connection” and an “electrical connection” through another intervening element. Unless otherwise defined, when any part includes any element, it may mean that any part further include other elements without excluding other elements.

Certain exemplary embodiments of the present disclosure will now be described in greater detail with reference to the accompanying drawings. In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present disclosure may be carried out without those specifically defined matters. Also, well-known functions or constructions are not described in detail since they would obscure the invention with unnecessary detail.

In the present disclosure, a user input may include at least one selected from a touch input, a bending input, a voice input, a button input, a motion input, and a multimodal input but is not limited thereto.

Also, in the present disclosure, a “touch input” may include a touch gesture performed on a display and a cover by a user to control an apparatus. In addition, the “touch input” may include a touch (e.g., floating or hovering) of a state where the user does not touch the display but keeps a preset distance or more from the display.

The touch input may be a touch and hold gesture, a releasing tap gesture after touch, a double tap gesture, a panning gesture, a flick gesture, a touch drag gesture moving in one direction after touch, a pinch gesture or the like but is not limited thereto.

Moreover, in the present disclosure, an “application” refers to a series of computer program sets designed to perform a particular task. Here, the application may be diverse. For example, the application may be a game application, a video play application, a map application, a memo application, a schedule application, a phone book application, a broadcast application, an exercise support application, a payment application, a photo folder application, a medical device control application, a user interface providing application of a plurality of medical devices, or the like but is not limited thereto.

Herein, a User Interface (UI) element refers to an element that enables an interaction with a user so as to enable visual, auditory, and olfactory feedbacks, and the like according to a user input.

Also, the term “user” may refer to a person who uses an electronic apparatus or an apparatus (e.g., an artificial intelligence (AI) electronic apparatus) that uses the electronic apparatus.

In addition, a video call mode used herein refers to a state where a video call is made and may include all operations from an operation of entering into the video call to an operation of ending the video call.

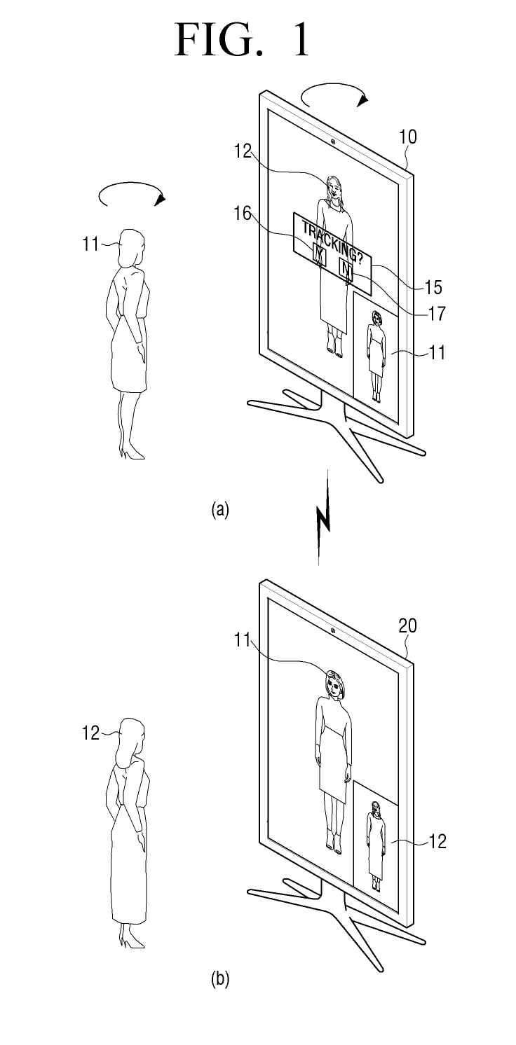

FIG. 1 is a view illustrating a situation where an electronic apparatus 10 tracks and captures a user 11 according to a position of the user 11 when making a video call to a counterpart terminal 20 according to an exemplary embodiment of the present disclosure.

Referring to FIG. 1, the electronic apparatus 10 and the counterpart terminal 20 are apparatuses that provide a video call. For example, the electronic apparatus 10 and the counterpart terminal 200 may be realized as smartphones, tablet personal computers (PCs), mobile phones, video phones, desktop PCs, laptop PCs, netbook computers, workstations, personal digital assistants (PDAs), mobile media devices, wearable devices, or the like.

According to another exemplary embodiment, the electronic apparatus 10 may be a home appliance. For example, the home appliance may include at least one selected from a television (TV), a refrigerator, an air conditioner, a vacuum cleaner, an oven, a microwave oven, a camcorder, and an electronic picture frame.

According to another exemplary embodiment, the electronic apparatus 10 may be a flexible electronic apparatus. The electronic apparatus 100 according to the exemplary embodiment of the present disclosure is not limited to devices described above and may include a new electronic apparatus with the technology development.

In the present disclosure, for convenience of description, an operation of the electronic apparatus 100 will be described aimed at for a display apparatus providing a video call like a smartphone, a desktop PC, or the like.

In FIG. 1, the electronic apparatus 10 may display a message 15 for tracking a position of a user, and receive a user command 16 or 17 from the user 11 during a video call. Here, if the user command 16 for tracking a position of the user is input, the electronic apparatus 10 may control at least one of a camera and a display to rotate according to a driving control signal. Through this, a screen of the electronic apparatus 10 may display the user 11 with rotating toward a direction of the user 11 who is tracked and captured and transmit an image, which is acquired by tracking and capturing the user 11, to the counterpart terminal 20. Therefore, the user 11 may not make a video call with carrying the electronic apparatus 10 during the video call but may make the video call with freely moving. Also, a counterpart 12 may continue a video call with looking at the user 11 in real time when the user 11 moves during the video call.

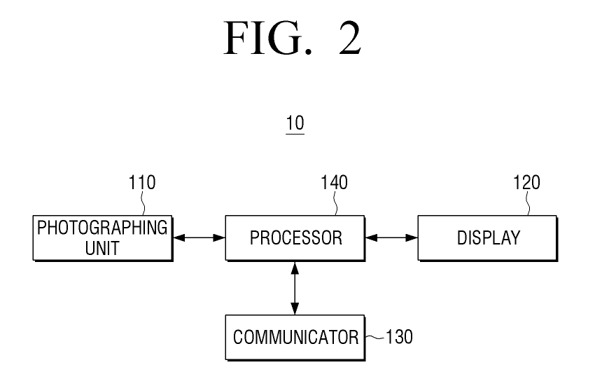

FIG. 2 is a block diagram of a simple configuration of an electronic apparatus 10, according to an exemplary embodiment of the present disclosure.

Referring to FIG. 2, the electronic apparatus 10 may include a photographing unit 110, a display 120, a communicator 130, and a processor 140.

The photographing unit 110 captures a front during a video call, and a captured image is transmitted to the counterpart terminal 20 through the communicator 130.

According to an exemplary embodiment of the present disclosure, the photographing unit 110 is a rotatable photographing unit and includes a motor (not shown) so as to rotate and track a particular person using a video call or a direction of the particular person according to a driving control signal of the processor 140. The photographing unit 110 may include a heat sensor, a motion recognition sensor, a voice recognition sensor, and the like.

The display 120 may display the user 11, who is making a video call and is captured by the photographing unit 11, and an image, which is received from the counterpart terminal 20 through the communicator 130, on one screen.

The display 120 may be constituted as a touch screen to be used as an input/output (I/O) unit. The display 120 may be realized as a Plasma Display Panel (PDP), a Liquid Crystal Display (LCD), an Organic Light Emitting Diode (OLED), a flexible display, a 3-dimensional (3D) display, or the like.

According to an exemplary embodiment of the present disclosure, the display 120 may include a rotatable display and include a motor (not shown) so as to rotate and track a particular person using a video call or a direction of the particular person according to a driving control signal of the processor 140. The display 120 may include a heat sensor, a motion recognition sensor, a voice recognition sensor, and the like.

Also, the display 120 may display a user interface for controlling the electronic apparatus 10.

The display 120 may display User Interfaces (UIs) respectively corresponding to commands so as to enable a user to select and input the commands.

The communicator 130 may perform communication with the counterpart terminal 20 according to various types of communication methods of the electronic apparatus 10. According to an exemplary embodiment of the present disclosure, the communicator 130 may communicate with at least one peripheral terminal apparatus while performing a video call. Also, the communicator 130 may change the video call by transmitting and receiving a video call change signal with the peripheral terminal apparatus 10-1 that is performing communication.

The communicator 130 may perform communication to transmit video call information and a video content to the counterpart terminal 20 and the peripheral terminal apparatus.

According to an exemplary embodiment, the communicator 130 may perform communication to remotely control a photographing unit of the counterpart terminal 20 while performing a video call. Here, the communicator 130 may include a radio frequency (RF) receiver and an RF transmitter that perform a wireless communication function.

If a designated command is input by a user while performing a video call, the processor 140 may control the photographing unit 110 to detect at least one person captured by the photographing unit 110, and track and rotate the detected person. Also, the processor 140 may control the display 120 to rotate, track, and display a person captured by the photographing unit 110.

According to an exemplary embodiment of the present disclosure, the processor 140 may detect a person closest to the electronic apparatus 10 among at least one person included in an image captured by the photographing unit 110. Here, the processor 140 may detect the closest person by determining a distance between a captured person and the electronic apparatus 10. The processor 140 may detect a distance based on a focal distance between a camera lens of the photographing unit 110 and a subject to be captured. Also, the processor 140 may detect a distance through a sensor (e.g., a heat sensor, a motion sensor, a voice recognition sensor, or the like) embedded in the electronic apparatus 10.

Also, the processor 140 may control the photographing unit 110 to track and capture a detected closest person. The processor 140 may control the communicator 130 to transmit an image of the closest person, who is tracked and captured, to the counterpart terminal 20.

According to another exemplary embodiment, if a person who is being tracked and captured through the photographing unit 110 strays from a designated capturing range, the processor 140 may control the photographing unit 110 to pause tracking and capturing. Also, if a person who is being tracked and captured through the photographing unit 110 strays from the designated capturing range for a designated time, the processor 140 may control the photographing unit 110 to return to an initial capturing position. Here, the processor 140 may control the photographing unit 110, which returns to the initial capturing position, to capture a front.

According to another exemplary embodiment, if a voice or a motion/gesture of the user 11 of the electronic apparatus 10 who indicates a particular direction is input during a video call, the processor 140 may control the photographing unit 110 to rotate in the direction indicated by the user 11.

According to another exemplary embodiment, if it is detected that a person detected by a peripheral terminal apparatus strays from a capturing range of the electronic apparatus 10 and enters into a capturing range of the peripheral terminal apparatus when the electronic apparatus 10 performs communication with the peripheral terminal apparatus through the communicator 130, the processor 140 may receive an event signal indicating that a person is detected, from the peripheral terminal apparatus. Here, in response to the received event signal, the processor 140 may control the communicator 130 to transmit video data, which is received from the counterpart terminal 20, to the peripheral terminal apparatus while performing a video call.

The processor 140 may control the display 120 to display a list of peripheral terminal apparatuses (not shown) that are performing communications with the electronic apparatus 10 and enable video calls. When a video call is changed to at least one peripheral terminal apparatus (not shown), the processor 140 may control the display 120 to display a message indicating that a screen is being changed to a peripheral terminal apparatus, not to display images of the user 11 and the counterpart 12.

According to another exemplary embodiment, if one of at least one person included in an image received from the counterpart terminal 20 is selected, the processor 140 may control the communicator 130 to transmit a signal which requests a photographing unit of the counterpart terminal 20 to track the selected person to the counterpart terminal 20.

According to another exemplary embodiment, if a user command for entering into a mode for remotely controlling the counterpart terminal 20 is input, the processor 140 may control the communicator 130 to transmit a remote control request signal to the counterpart terminal 20. Here, if a signal accepting a remote control request is received from the counterpart terminal 20, the processor 140 may control the display 120 to display an UI for controlling the counterpart terminal 20.

According to another exemplary embodiment, if the user 11 utters a name of one of at least one person included in an image received from the counterpart terminal 20, the processor 140 may control the communicator 130 to transmit a signal for requesting the photographing unit of the counterpart terminal 20 to track and capture the uttered person and utterance information to the counterpart terminal 20. Here, the utterance information may be counterpart information that is mapped on a phone book, messages, e-mails, Social Network Services (SNSs), albums, phone numbers stored in an application and the like, names, nicknames, photos, and the like of the electronic apparatus 10.

Here, the processor 140 may control the photographing unit 110 to rotate in a direction of an utterer by recognizing a voice of the utterer and to track and capture the utterer.

The processor 140 may be realized to recognize an utterer when an input voice level is higher than or equal to or is within a designated value based on a voice input level of the utterer. However, this is merely an exemplary embodiment for describing the present disclosure but is not limited thereto. Therefore, the processor 140 may be realized to recognize an utterer through various types of techniques and methods.

According to another exemplary embodiment, if a user command for entering into a content share mode and a user command for a video content full screen view are input by the user 11 while using a video call, the processor 140 may control the display 120 to automatically display a full screen according to a screen ratio at which a video content is played. Here, if a designated user command for tracking and capturing is input by the user 11, the processor 140 may control the display 120 to automatically rotate and display a video content, which is being played, according to a position of a user.

When the electronic apparatus 10 wants to share a video content with the counterpart terminal 20, the processor 140 may control the display 120 to display at least one of content lists respectively corresponding to at least one determined contents.

Also, the processor 140 may control the display 120 to display a warning message when the electronic apparatus 100 enters from a video call mode into another function and another mode or fails to enter into the another function and the another mode.

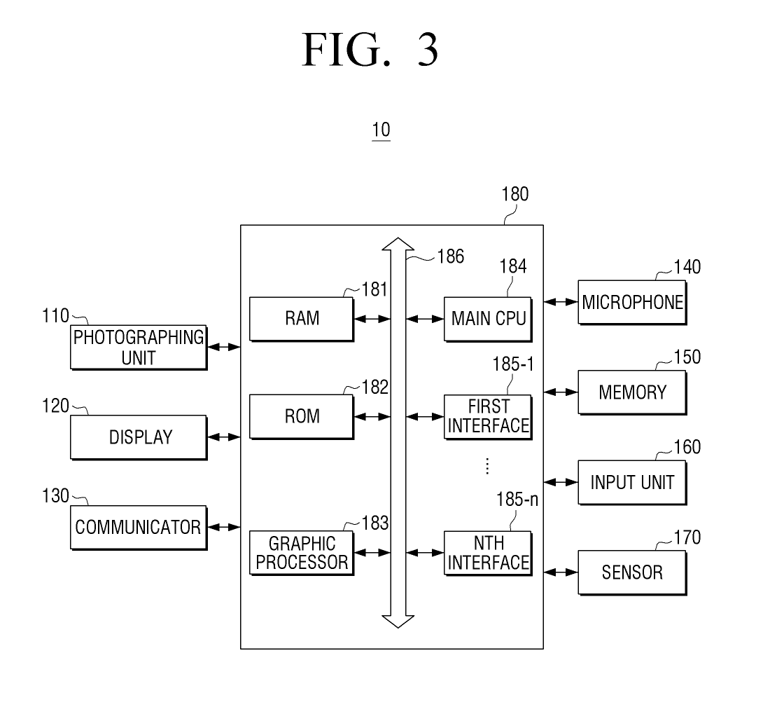

FIG. 3 is a block diagram of a detailed configuration of an electronic apparatus 100, according to another exemplary embodiment of the present disclosure.

As shown in FIG. 3, the electronic apparatus 10 may include at least one selected from a photographing unit 110, a display 120, a communicator 130, a microphone 140, a memory 150, an input unit 160, a sensor 170, and a processor 180. Elements of the electronic apparatus 10 shown in FIG. 3 are merely an example and thus are not necessarily limited to a block diagram described above. Therefore, some of the elements of the electronic apparatus 10 may be omitted, modified, or added according to a type or a purpose of the electronic apparatus 10.

The photographing unit 110 may be a rotatable camera unit and acquire image data by capturing an external environment through a camera. The photographing unit 10 may include a lens (not shown) through which an image is penetrated and an image sensor (not shown) senses the image that penetrates through the lens. The image sensor (not shown) may be realized as a Charge Coupled Device (CCD) image sensor or a Complementary Metal Oxide Semiconductor (CMOS) image sensor. The image data acquired through the photographing unit 110 may be processed through image-processing.

The photographing unit 110 may perform various types of image-processing, such as decoding, scaling, noise filtering, frame rate converting, resolution converting, and the like, with respect to the captured image data.

The display 120 displays an image, which is processed by the photographing unit 110 during a video call, and an image, which is acquired from the counterpart terminal 20 and received from the communicator 130, in a display area. Here, the display 120 may display the image processed by the photographing unit 110 on a main screen and display the image received from the counterpart terminal 20 on a sub screen. On the contrary, the display 120 may display the image received from the counterpart terminal 20 on the main screen and display the image processed by the photographing unit 110 on the sub screen.

According to an exemplary embodiment of the present disclosure, the display 120 may include a rotatable screen including a motor. The display 120 may rotate and display an image, which is tracked and captured by the photographing unit 110, by tracking a user according to a driving control signal of the processor 180.

The display 120 displays a moving image frame, which is generated by processing image data through an image processor (not shown), or at least one selected from various types of screens, which are generated by a graphic processor (not shown), in the display area.

The display 120 may have various sizes. The display 120 may have various resolutions including a plurality of pixels.

The display 120 may be combined as a flexible display type with at least one selected from a front area, a side area, and a back area of the display apparatus 10. A flexible display may have a characteristic by which a thin and flexible substrate like paper may be crooked, bent, or rolled without damage. The flexible display may be manufactured by using a generally used glass substrate or a plastic substrate. If the plastic substrate is used, the plastic substrate may be formed by using a low-temperature manufacturing process without using an existing manufacturing processor in order to prevent damage to the plastic substrate. Also, a glass substrate enclosing a flexible liquid crystal may be replaced with a plastic film so as to give flexibility enabling folding and unfolding. The flexible display may be thin, light, shock-resistant, crooked, bent, and manufactured as various types.

The display 120 may be combined with a touch sensor (not shown) to be realized as a touch screen having a layer structure. The touch screen may have a display function, a function of detecting a touch input position, a touched area, and a touch input pressure, and a function of detecting a real touch and a proximity touch. Also, the touch screen may have a function of detecting a finger touch of a user and various types of pen touches.

The communicator 130 is an element that performs communications with various types of external devices according to various types of communication methods.

According to an exemplary embodiment of the present disclosure, the communicator 130 performs communication for a video call with the counterpart terminal 20. Also, the communicator 130 performs communication so as to change a video call with performing wireless communication. The communicator 130 may perform communication so as to share a video content during a video call.

The communicator 130 may include at least one selected from a wireless fidelity (WiFi) (not shown), a Bluetooth chip (not shown), a wireless communication chip (not shown), and a Near Field Communication (NFC) chip. The processor 180 may perform communication with an external server or various types of external devices by using the communicator 130.

In particular, the WiFi chip (not shown) and the Bluetooth chip (not shown) may respectively perform communications according to a WiFi method and a Bluetooth method. If the WiFi chip (not shown) or the Bluetooth chip (not shown) is used, the communicator 130 may first transmit and receive various types of connection information, such as a subsystem identification (SSID), a session key, and the like, and then transmit and receive various types of information after connecting communication by using the various types of connection information. The wireless communication chip (not shown) refers to a chip that performs communication according to various types of communication standards such as Institute of Electrical and Electronics Engineers (IEEE), Zigbee, 3^{rd} Generation, 3^{rd} Generation Partnership Project (3GPP), Long Term Evolution (LTE), and the like. The NFC chip (not shown) refers to a chip that operates according to an NFC method using a band of 13.56 MHz among various radio frequency identification (RFID) frequency bands such as 135 kHz, 13.56 MHz, 433 MHz, 860-960 MHz, 2.45 GHz, and the like.

The microphone 140 may recognize a user voice through a voice recognition module by receiving a user voice for controlling the electronic apparatus 10 through the electronic apparatus 10. Also, the microphone 140 may transmit a recognized result to the processor 180. Here, the voice recognition module may be positioned in a part of the processor 180 or outside the electronic apparatus 10 not in the microphone 140.

According to an exemplary embodiment of the present disclosure, a user voice recognition may be a particular language indicating a direction. For example, the user voice recognition may be “Look at there”, “Look at here”, “Look at me”, “Over there”, “Here”, “Up”, “Down”, or the like.

Also, according to another exemplary embodiment, the user voice recognition may be a name, a nickname, or the like of a counterpart whose name is uttered by the user making a video call.

The memory 150 may store various types of programs and data necessary for an operation of the electronic apparatus 10. The memory 150 may be realized as a nonvolatile memory, a volatile memory, a flash memory, a hard disk drive, a solid state drive (SSD), or the like. The memory 150 may be accessed by the processor 180, and reading/recording/revising/deleting/updating, and the like of data may be performed by the processor 190 with respect to the memory 150. The term “memory” used herein may include the memory 150, a Read Only Memory (ROM) 182 and a Random Access Memory (RAM) 181 of the processor 180, or a memory card (e.g., a micro Secure Digital (SD) card, a memory stick, or the like) installed in the electronic apparatus 10.

Also, the memory 150 may store a program, data, and the like for constituting various types of screens that will be displayed in the display area of the display 120.

According to an exemplary embodiment of the present disclosure, the memory 150 may store information on which a particular word for a user voice recognition during a video call and a camera position of the photographing unit 110 are mapped, and the like. Also, if the user utters a name of at least one person included in an image transmitted from the counterpart terminal 20 in a video call mode, the memory 150 may store photo information, contact number information, and the like of an counterpart mapped on a name, a nickname, and the like of the counterpart.

Software elements shown in FIG. 3 are merely examples and thus are not necessarily limited thereto. Therefore, some of the software elements may be omitted, modified, or added according to a type or a purpose of the electronic apparatus 10. For example, the memory 150 may further include various types of programs such as a sensing module for analyzing signals sensed by various types of sensors, a messaging module such as a messenger program, a text message program, an email program, or the like, a Call Info Aggregator program module, a Voice over Internet Protocol (VoIP) module, a web browser module, and the like.

The input unit 160 transmits a signal, which is input by the user, to the processor 180 or transmits a signal of the processor 180 to the user. For example, the input unit 160 may receive a user input signal or a control signal, such as power on/off, screen setting, or the like from a remote control device (not shown), and process the user input signal or the control signal or may process a control signal received from the processor 180 so as to transmit the control signal to the remote control device according to various types of communication methods such as Bluetooth, RFID, Infrared Data Association (IrDA), Ultra Wideband (UWB), Zigbee, and Digital Living Network Alliance (DLNA) communication methods, and the like.

For example, the input unit 160 may transmit a user input signal or a control signal input from the sensor 170 sensing a gesture of the user or may transmit a signal received from the processor 180 to the sensor 170.

Also, if the electronic apparatus 10 performs a video call change operation, the input unit 160 may receive a video call change command, a command for selecting a peripheral terminal apparatus, which will change a video call, or the like and transmit the video call change command, the command, or the like to the processor 180.

The sensor 170 senses various types of UIs. The sensor 170 may detect at least one selected from various changes such as a position change, an illuminance change, an acceleration change, and the like of the electronic apparatus 10 and transmit an electrical signal corresponding to the at least one change to the processor 180. In other words, the sensor 170 may sense a state change made based on the electronic apparatus 10, generate a sensing signal according to the state change, and transmit the sensing signal to the processor 180.

In the present disclosure, the sensor 170 may include various types of sensors and may sense a state change of the electronic apparatus 10 by supplying power to at least one sensor set under control of the sensor 170 when driving the electronic apparatus 10 (or based on user setting).

The sensor 170 may include various types of sensors and may include at least one electronic device selected from all types of sensing electronic devices capable of detecting a state change of the electronic apparatus 10. For example, the sensor 170 may include at least one sensor selected from various types of sensing electronic devices such as a touch sensor, an acceleration sensor, a gyro sensor, an illuminance sensor, a proximity sensor, a pressure sensor, a noise sensor (e.g., a microphone), a video sensor (e.g., a camera module), a pen sensor, a timer, and the like.

The sensor 170 may be classified into a voice sensor (not shown), a touch sensor (not shown), a motion sensor (not shown), and the like according to sensing purposes but is not limited thereto. Therefore, the sensor 170 may be classified according to more various purposes. This does not mean a physical classification, and at least two sensors may be combined to perform roles of the sensors (not shown). Also, some of elements or functions of the sensor 170 may be included in the processor 180 according to realization methods.

The voice sensor (not shown) may sense an utterer by using a voice level input from the microphone 140.

The motion sensor (not shown) may sense a motion (e.g., a rotation motion, a tilting motion, or the like) of the electronic apparatus 10 by using at least one selected from an acceleration sensor, a tilt sensor, a gyro sensor, and a 3-axis magnetic sensor. Also, the motion sensor (not shown) may transmit a generated electrical signal to the processor 180. For example, the motion sensor (not shown) measures acceleration where motion acceleration and gravity acceleration of the electronic apparatus 10 are added but may measure merely gravity acceleration if there is no motion of the electronic apparatus 10.

For example, if the motion sensor (not shown) uses the acceleration sensor, gravity accelerations may be respectively measured with respect to X axis, Y axis, and Z axis based on the electronic apparatus 10. Here, facing up of a front surface of the electronic apparatus 100 will be described as a positive (+) direction of gravity acceleration, and facing up of a back surface of the electronic apparatus 10 will be described a negative (−) direction of the gravity acceleration. If the back surface of the electronic apparatus 10 is put to touch a horizontal plane, X axis and Y axis components of the gravity acceleration measured by the motion sensor (not shown) may be measured as 0 m/sec², and merely a Z axis component of the gravity acceleration may be measured as a particular positive value (e.g., +9.8 m/sec²). On the contrary, if the front surface of the electronic apparatus 10 is put to touch the horizontal plane, the X axis and Y axis components of the gravity acceleration measured by the motion sensor (not shown) may be measured as 0 m/sec², and merely the Z axis component of the gravity acceleration may be measured as a particular negative value (e.g., −9.8 m/sec²). In addition, if the electronic apparatus 10 is slantly put with respect to a surface of a table, at least one axis of the gravity acceleration measured by the motion sensor (not shown) may be measured as a value that is not 0 m/sec². Here, a square root of a sum of a product of components of three axes, i.e., a size of a vector sum, may be the particular value (e.g., 9.8 m/sec²). In the above-described example, the motion sensor (not shown) may sense accelerations with respect to X axis, Y axis, and Z axis directions on a coordinate system. X axis, Y axis, and Z axis and gravity accelerations of the X axis, Y axis, and Z axis may be changed according to an attached position of a sensor.

The sensor 170 may further include a pen sensor (e.g., a pen recognition panel) (not shown). The pen sensor may sense a pen input of the user according to an operation of a touch pen of the user (e.g., a stylus pen, a digitizer pen, or the like) and output a pen proximity event value or a pen touch event value. For example, the pen sensor may be realized as an Electromagnetic Radiation (EMR) type and may sense a touch or proximity input according to a change in an intensity of an electromagnetic field caused by a pen proximity or a pen touch. In detail, the pen recognition panel may include an electromagnetic induction coil sensor that has a grid structure and an electronic signal processor that sequentially respectively provides loop coils of the electromagnetic induction coil sensor with alternating current (AC) signals having preset frequencies. If a pen including a resonant circuit exists around a loop coil of the pen recognition panel, a magnetic field transmitted from the corresponding loop coil generates a current in the resonant circuit of the pen based on a mutual electromagnetic induction. Based on this current, an induction field is generated from a coil constituting the resonant circuit of the pen, and the pen recognition panel may detect the induction field from a loop coil, which is in a signal reception state, so as to sense a proximity position or a touch position of the pen.

The processor 180 may control an overall operation of the electronic apparatus 10 by using various types of programs stored in the memory 150.

The processor 180 may include the RAM 181, the ROM 182, a graphic processor 183, a main central processing unit (CPU) 184, first through n^{th} interfaces 185-1 through 185-n, and a bus 186.

Here, the RAM 181, the ROM 182, the graphic processor 183, the main CPU 184, the first through n^{th} interfaces 185-1 through 185-n, and the like may be connected to one another through the bus 186.

The RAM 181 stores an operating system (O/S) and an application program. In detail, if the electronic apparatus 10 is booted, the O/S may be stored in the RAM 181, and various types of application data selected by the user may be stored in the RAM 181.

The ROM 182 stores a command set and the like for system booting. If power is supplied by inputting a turn-on command, the main CPU 184 copies the O/S stored in the memory 150 into the RAM 181 and executes the O/S to boot a system according to the command stored in the ROM 182. If the system is completely booted, the main CPU 184 copies various types of application programs stored in the memory 150 into the RAM 181 and executes the application programs copied into the RAM 181 to perform various operations.

The graphic processor 183 generates a screen including various types of objects, such as an item, an image, a text, and the like, by using an operator (not shown) and a renderer (not shown). Here, the operator may be an element that calculates attribute values, such as coordinate values at which objects will be respectively displayed, shapes, and sizes of the objects, and the like, according to a layout of a screen by using a control command received from the sensor 170. Also, the renderer may be an element that generates a screen of various layouts including objects based on the attribute values calculated by the operator. The screen generated by the renderer may be displayed in a display area of the display 120.

The main CPU 184 performs booting by using the O/S stored in the memory 150 by accessing the memory 150. Also, the main CPU 184 performs various operations by using various types of programs, contents, data, and the like stored in the memory 150.

The first through n^{th} interfaces 185-1 through 185-n are connected to various types of elements described above. One of the first through n^{th} interfaces 185-1 through 185-n may be a network interface that is connected to a counterpart terminal through a network.

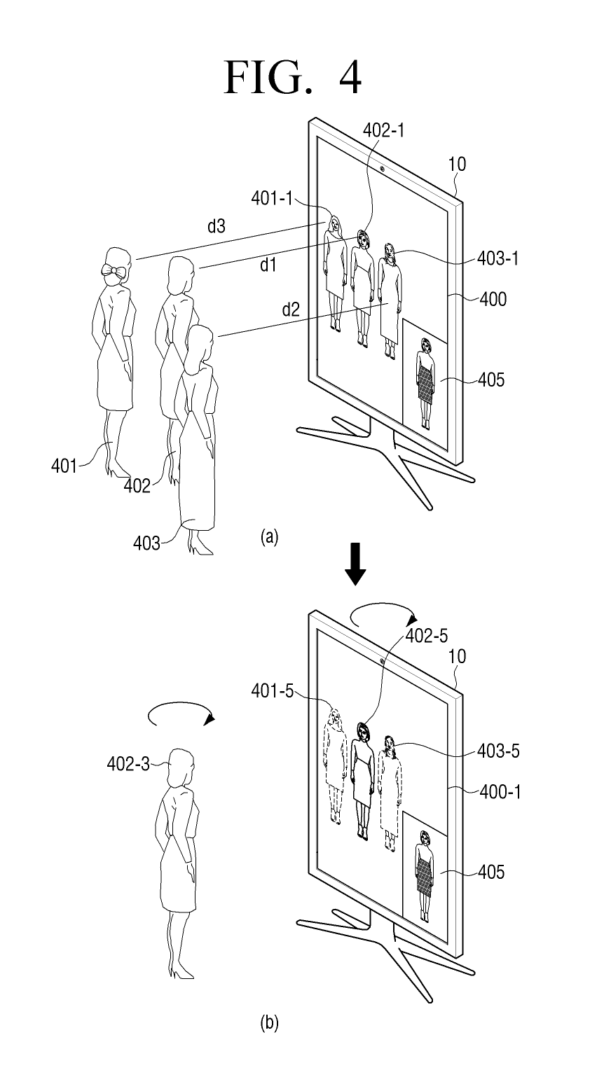

FIG. 4 is a view illustrating tracking and capturing a person closest to the electronic apparatus 10 in a video call mode, according to an exemplary embodiment of the present disclosure.

Referring to FIG. 4, the electronic apparatus 10 captures a front of the electronic apparatus 10 during a video call and displays the captured front on a display 400 of the electronic apparatus 10. The electronic apparatus 10 may capture at least one of persons 401, 402, and 403 positioned in a capturing range of the electronic apparatus 10 among persons 401, 402, and 403 who participate in a video call in front of the electronic apparatus 10.

At least one of persons 401-1, 402-1, and 403-1 that are captured may be displayed on a main screen or a sub screen of the display 400 of the electronic apparatus 10. In the present exemplary embodiment, the electronic apparatus 10 is used to display the users 401, 402, and 403, who participate in the video call, on the main screen and display an image of a counterpart 405 received from the counterpart terminal 20 on the sub screen. However, this is merely an exemplary embodiment for describing the present disclosure but is not limited thereto. Therefore, positions of the main screen and the sub screen may be variously realized in the electronic apparatus 10. Also, the electronic apparatus 10 may be realized to display merely one of the main screen and the sub screen on the display 400.

The electronic apparatus 10 may detect a person 402-5 closest to the electronic apparatus 10 among persons captured in front of the electronic apparatus 10. The electronic apparatus 10 may capture a front with tracking a position of the detected person 402-5. Here, the display 400 of the electronic apparatus 10 may rotate with tracking a position of the captured person 402-5 to display the captured person 402-5 and the counterpart 405 in real time. When the electronic apparatus 10 tracks and captures the person 402-5 closest to the electronic apparatus 10, other persons 401-5 and 403-5 may not be displayed in a display area 400-1 due to a movement of the closest person 402-5.

The electronic apparatus 10 may determine and analyze distances d1, d2, and d3 between the persons 401, 402, and 403 positioned in front of the electronic apparatus 10 and the electronic apparatus 10. The electronic apparatus 10 may determine the person 402 who will be tracked based on the determined distances d1, d2, and d3 between the persons 401, 402, and 403 and the electronic apparatus 10. Here, the electronic apparatus 10 may determine a distance between a person positioned in front of the electronic apparatus 10 and the electronic apparatus 10 through a sensor (e.g., a heat sensor, a voice recognition sensor, or the like) included in a camera and determine the distance between the person and the electronic apparatus 10 through a sensor included in a display. Also, the electronic apparatus 10 may determine the distance between the person and the electronic apparatus 10 through a focal distance at which a lens of a camera focuses on a person to be captured. However, this is merely an exemplary embodiment for describing the present disclosure, and thus the electronic apparatus 10 may measure and determine distances from the electronic apparatus 10 to the persons 401, 402, and 403 positioned in front of the electronic apparatus 100 through various types of techniques and methods.

The present disclosure illustrates an exemplary embodiment where the electronic apparatus 10 is put in a holder to describe a rotation of a display of the electronic apparatus 10 but is not limited thereto. A motor that rotates the display of the electronic apparatus 10 may be mounted in the holder to rotate the display or may be mounted in the electronic apparatus 10 to rotate the display.

For example, if the user makes a video call with holding a smartphone 10 with a hand and selects a tracking and capturing function during the video call shown in FIG. 1, the electronic apparatus 10 may be fixed with the hand of the user, but the camera may capture a front with rotating a position change of the user.

The electronic apparatus 10 rotates in a vertical direction (e.g., 3:4, 9:16, or the like) in the present disclosure but may rotate in a horizontal direction (e.g., 4:4, 16:9, or the like) to perform tracking and capturing.

Also, the electronic apparatus 10 tracks and captures a whole body of the user who is making a video call in the present disclosure but may be realized to zoom out, track, and capture a face part of the user. In addition, the electronic apparatus 10 may put a face of the user in a center of a screen, and track and capture positions of eyes of the user.

The electronic apparatus 10 may select a particular part (e.g., a whole body, a face, eyes, or the like) of a user, who is positioned in front of the electronic apparatus 10, through a UI so as to track and capture the particular part.

When capturing a front during a video call, the electronic apparatus 10 may move in up, down, left, and right directions, and rotate and capture the front so as to enable the front to correspond to a position change speed of a user. Also, the electronic apparatus 10 may rotate and display a captured image in up, down, left, and right directions so as to enable the captured image to correspond to a position change speed of a user.

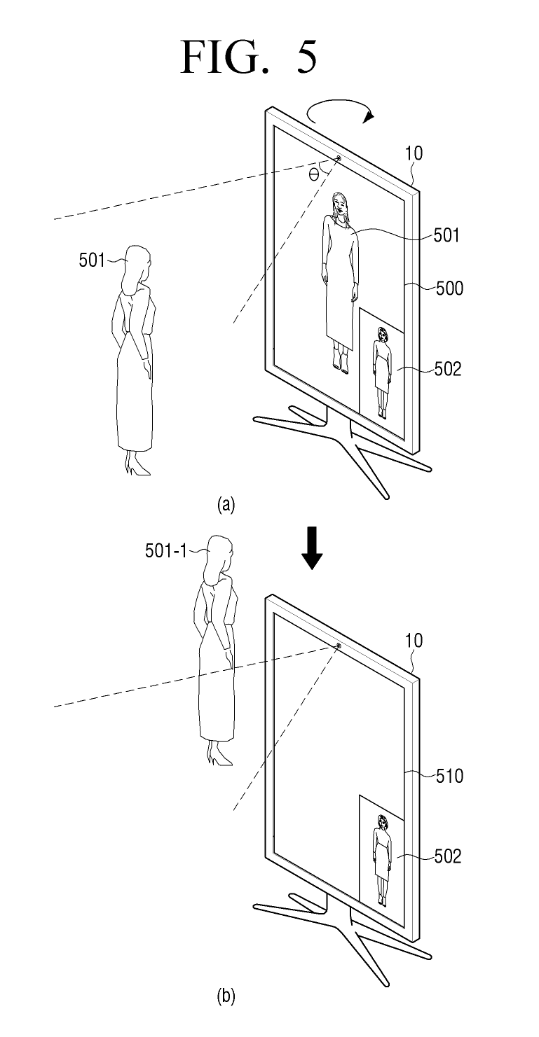

FIG. 5 is a view illustrating tracking and capturing if a user strays from a designated capturing range of an electronic apparatus during a video call, according to an exemplary embodiment of the present disclosure.

When a user 501 moves within a capturing range (a capturing angle) of the electronic apparatus 10, the electronic apparatus 10 tracks and captures the user 501, and a display area 500 rotates toward the user 501 to display a captured image. However, when a user 501-1 moves not to exist in a designated capturing range (a capturing angle) of the electronic apparatus 10, the electronic apparatus 10 displays an image of a counterpart 502 received from the counterpart terminal 20 and an image of a front of the electronic apparatus 10 in a display area 510.

For example, a capturing angle of a designated capturing range where the electronic apparatus 10 is capable of capturing an image for a video call may be 180 degrees, and a capturing distance of the capturing range may be 3 meters ahead. Here, the user 501 may be positioned at the back of the electronic apparatus 10 so as to enable a capturing angle of the electronic apparatus 10 to exist in an area except 180 degrees. Here, the electronic apparatus 10 may pause tracking the user 501 and transmit the image of the front to the counterpart 502. Also, if the user 501 is at a distance of 3 meters or more ahead from the electronic apparatus 10, the electronic apparatus 10 may pause tracking the user 501, capture the image of the front, and transmit the captured image to the counterpart terminal 20. However, this is merely an exemplary embodiment for describing the present disclosure, and a capturing angle and a capturing distance are not limited thereto. Therefore, the capturing angle and the capturing distance may be variously realized.

Also, if the user 501 strays from a designated capturing range of the electronic apparatus 10 for a designated time during a video call, the electronic apparatus 10 rotates a display to an initial capturing position to transmit a captured image of the front to the counterpart terminal 20.

For example, if a user strays from a designated capturing range for 5 seconds or more in a video call mode, the electronic apparatus 10 may display a notification message for notifying straying from the designated capturing range on a display or may notify the user of straying from the designated capturing range through a voice output. If 5 seconds or more pass after the electronic apparatus 10 notifies the user of the notification message, the electronic apparatus 10 may track the user to rotate the rotated display into an initial capturing position so as to transmit the captured image of the front to the counterpart 502.

Also, for example, the electronic apparatus 10 may be realized to transmit the notification message to the user and immediately transmit an image, which is acquired by rotating the display to the initial capturing position and capturing the front, to the counterpart 502.

In addition, for example, when the user strays from the designated capturing range of the electronic apparatus 10 for 5 seconds or more, the electronic apparatus 10 may not notify the user of the notification message and immediately transmit the image, which is acquired by rotating the display to the initial capturing position and capturing the front, to the counterpart 502.

The above-described exemplary embodiments are merely examples for describing the present disclosure but are not limited thereto. Therefore, various designated times and various designated capturing ranges may be set.

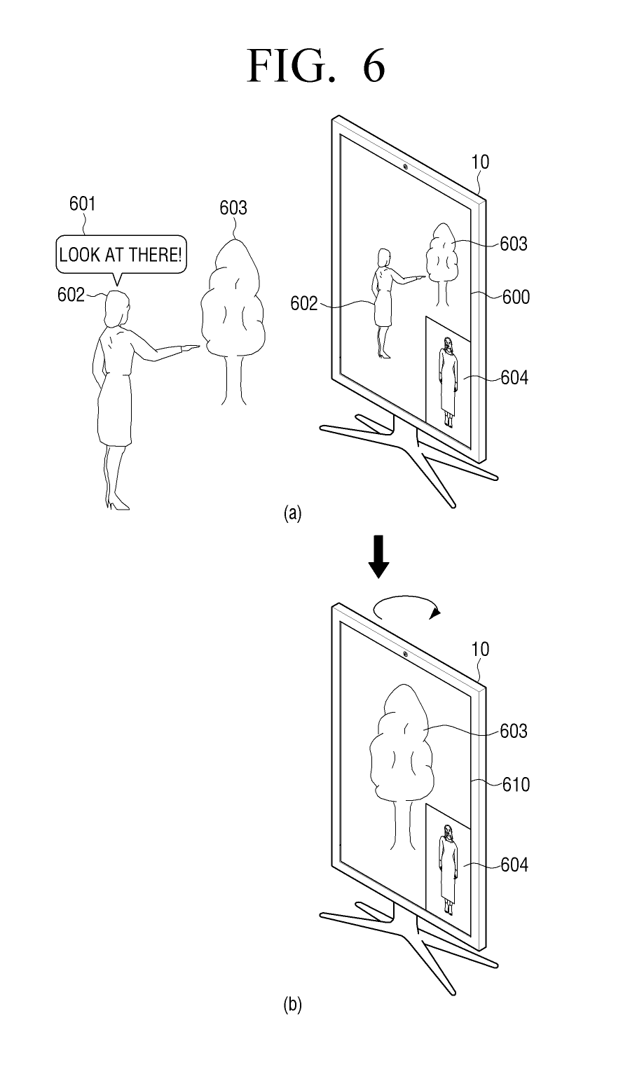

FIG. 6 is a view illustrating tracking and capturing performed by an electronic apparatus during a video call based on a voice recognition and a motion recognition of a user, according to an exemplary embodiment of the present disclosure.

Referring to FIG. 6, the electronic apparatus 10 may capture a user 602 and a subject 603 positioned in front and display the user 602 and the subject 603 in a display area 600. The electronic apparatus 10 may recognize a particular language 601 uttered from the captured user 602. Also, the electronic apparatus 10 may recognize a motion of the user 602. The electronic apparatus 10 may map the voice-recognized particular language 610 and the motion of the user 602, rotate a camera in a direction indicated by the user 602, capture the front, and display a captured image in a display area 610 based on mapped information.

For example, if the user 602 utters “Look at there” with pointing to a front tree with a finger, the electronic apparatus 10 may analyze and map the particular language 601 “Look at there” and a tilt angle between a position of an arm of the user 602 and a position of an end of a finger. The electronic apparatus 10 may rotate a capturing position of the camera in a designated direction based on the mapped information to display an image 603, which is acquired by capturing the subject 603 in a direction indicated by the user 602, in the display area 610. Here, if the subject 603 indicated by the user 602 is within a designated capturing distance of the electronic apparatus 10 and is positioned in a longer distance than the user 602, the electronic apparatus 10 may zoom out the subject 603 and then display the subject 603 in the display area 610. Therefore, a counterpart 604 may make a video call with seeing the subject 603 of a direction, toward which the user 602 wants to show the subject 603, in real time.

Here, the electronic apparatus 10 may be realized through a motion recognition sensor that recognizes a motion of a user. Also, the electronic apparatus 10 may be realized as a voice recognition sensor that recognizes a voice of the user.

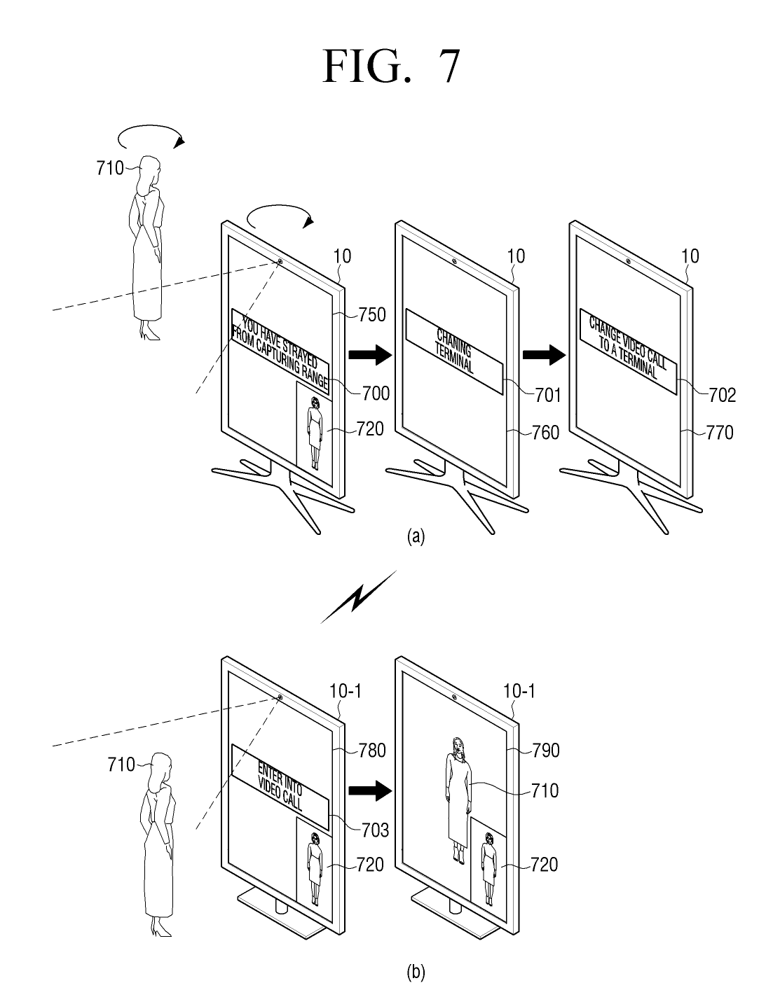

FIG. 7 is a view illustrating the electronic apparatus 10 that changes a video call to a peripheral terminal apparatus 10-1 during the video call, according to an exemplary embodiment of the present disclosure.

Referring to FIG. 7, the electronic apparatus 10 may track a user 710 positioned in front, display a captured image in a display area 750, and transmit the captured image to a counterpart 720. Here, when the user 710 strays from a designated capturing range of the electronic apparatus 10, the electronic apparatus 10 may display an UI 700 including information indicating that the user 710 strays from the designated capturing range, in the display area 750. Also, the electronic apparatus 10 may output the corresponding information with a voice to notify the user 710 of the corresponding information.

Here, when the electronic apparatus 10 communicates with at least one peripheral terminal apparatus 10-1 providing a video call function, and the user 710 enters into a designated capturing range of the at least one peripheral terminal apparatus 10-1 that is communicating with the electronic apparatus 10, the electronic apparatus 10 may search for the peripheral terminal apparatus 10-1 that will change a video call.

Also, the electronic apparatus 10 may display a message, which is being prepared to change a video call to the peripheral terminal apparatus 10-1, in a display area 760 through an UI.

For example, the UI displayed in the display area 760 may be a list of the searched at least one peripheral terminal apparatus 10-1. Also, the UI displayed in the display area 760 may be a list of at least one peripheral terminal apparatus 10-1 that is in a radius of a designated position from the electronic apparatus 10.

The electronic apparatus 10 may receive one of a list of peripheral terminal apparatuses 10-1 displayed by the user through a user command. Here, a user input may be a touch, touch and drag, an external input method (e.g., a remote controller, a button input, a motion input, a voice recognition, or the like), or the like. However, this is merely an exemplary embodiment for describing the present disclosure and is not limited thereto.

The electronic apparatus 10 may receive an event signal for notifying that the user 710 is detected, from the searched at least one peripheral terminal apparatus 10-1. The electronic apparatus 10 may display a message notifying that a video call will be changed to the peripheral terminal apparatus 10-1, in a display area 770 based on a signal received from the peripheral terminal apparatus 10-1. Here, the message displayed in the display area 770 may be output as a voice to be informed to the user 710.

If it is detected that the user 710 enters into a designated capturing range, the peripheral terminal apparatus 10-1 may display a message notifying that the user 710 enters into a video call, in a display area 780. Here, the peripheral terminal apparatus 10-1 may inform the user 710 of a video call entrance message as a voice. The electronic apparatus 10 may transmit image data that the electronic apparatus 10 receives from the counterpart terminal 20 during a video call, to the peripheral terminal apparatus 10-1 in response to an event signal received from the peripheral terminal apparatus 10-1. Therefore, the peripheral terminal apparatus 10-1 may continuously perform a video call that is being performed through the electronic apparatus 10. The user 710 is displayed in a display area 790 of the peripheral terminal apparatus 10-1, and the user 710 captured by the peripheral terminal apparatus 10-1 is transmitted to a counterpart 720.

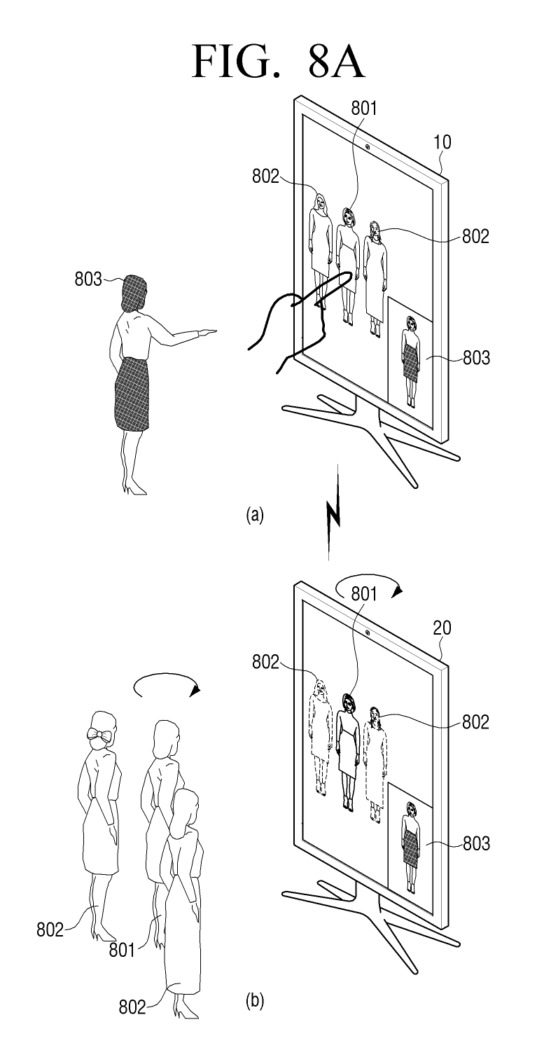

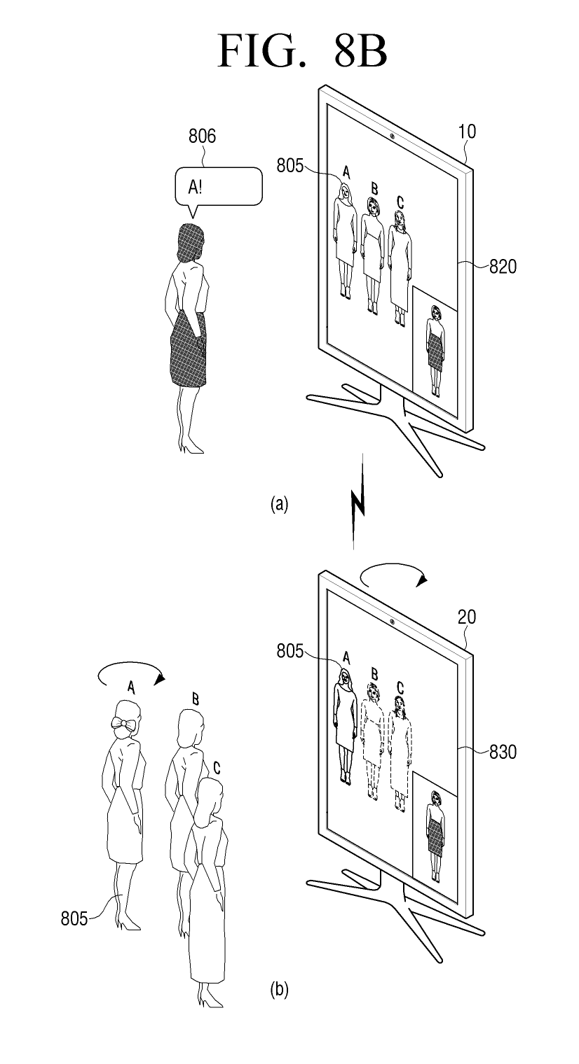

FIGS. 8A and 8B are views illustrating selecting, tracking, and capturing a particular person from an image transmitted from the counterpart terminal 20 during a video call, according to an exemplary embodiment of the present disclosure.

Referring to FIG. 8A, the electronic apparatus 10 displays an image acquired by capturing a user 803 positioned in front and images 801 and 802 captured and transmitted by a user terminal 20 in a display area. Here, the user 803 may select at least one person included in an image transmitted from the counterpart terminal 20. The user 803 may select at least one person included in the image according to a touch input method through a touch screen of the electronic apparatus 10. Also, the user 803 may select at least one person included in the image according to an external input method (e.g., a remote controller, a button input, a motion input, a voice recognition, or the like) of the electronic apparatus 10.

The electronic apparatus 10 may transmit a signal to the counterpart terminal 20 so as to request the counterpart terminal 20 to track and capture at least one person 801 selected from the image received from the counterpart terminal 20. The counterpart terminal 20 may track and capture the person 801 selected from persons 801 and 802 positioned in front of the counterpart terminal 20 based on request information received from the electronic apparatus 10. The counterpart terminal 20 may transmit the captured and selected person 801 to the electronic apparatus 10.

In order to describe an exemplary embodiment of the present disclosure, an image captured by the counterpart terminal 20 is displayed on a main screen of the electronic apparatus 10. Also, an image captured by the counterpart terminal 20 is displayed on a main screen in a display area of the counterpart terminal 20. However, this is merely an exemplary embodiment for describing the present disclosure and is not limited thereto.

Referring to FIG. 8B, when a user 806 utters a name of at least one of persons A, B, and C included in an image transmitted from the counterpart terminal 20, the electronic apparatus 10 may recognize the uttered name as a voice. For example, when the user 806 utters a name of “person A 805” included in the image that is transmitted from the counterpart terminal 20 and then displayed on the electronic apparatus 10, the electronic apparatus 10 may map utterance information (e.g., a nickname, a pet name, address book information, message information, image information, and the like) associated with the name of the person A 805 stored in the electronic apparatus 10 on the person A 805 to transmit a signal for requesting tracking of the person A 805 to the counterpart terminal 20.

The counterpart terminal 20 may track and capture the uttered person 805 among persons positioned in front of the counterpart terminal 20 based on the utterance information received from the electronic apparatus 10. The electronic apparatus 10 may receive the person 805, which is captured and selected by the counterpart terminal 20, from the counterpart terminal 20.

The electronic apparatus 10 may recognize the user 806, who is an utterer, to track and capture the utterer 806 in a direction of the utterer 806. For example, when a plurality of users are positioned in front of the electronic apparatus 10 and participate in a video call, the electronic apparatus 10 may detect an utterer based on input voice levels of the plurality of users. For example, the electronic apparatus 10 may detect a person having a highest input voice level as an utterer. Alternatively, the electronic apparatus 10 may detect an utterer when a voice included in an input voice level range designated is input into the electronic apparatus 10.

In order to describe an exemplary embodiment of the present disclosure, an image captured by the counterpart terminal 20 is displayed on a main screen of the electronic apparatus 10. Also, an image captured by the counterpart terminal 20 is displayed on a main screen of a display area of the counterpart terminal 20. However, this is merely an exemplary embodiment for describing the present disclosure and is not limited thereto.

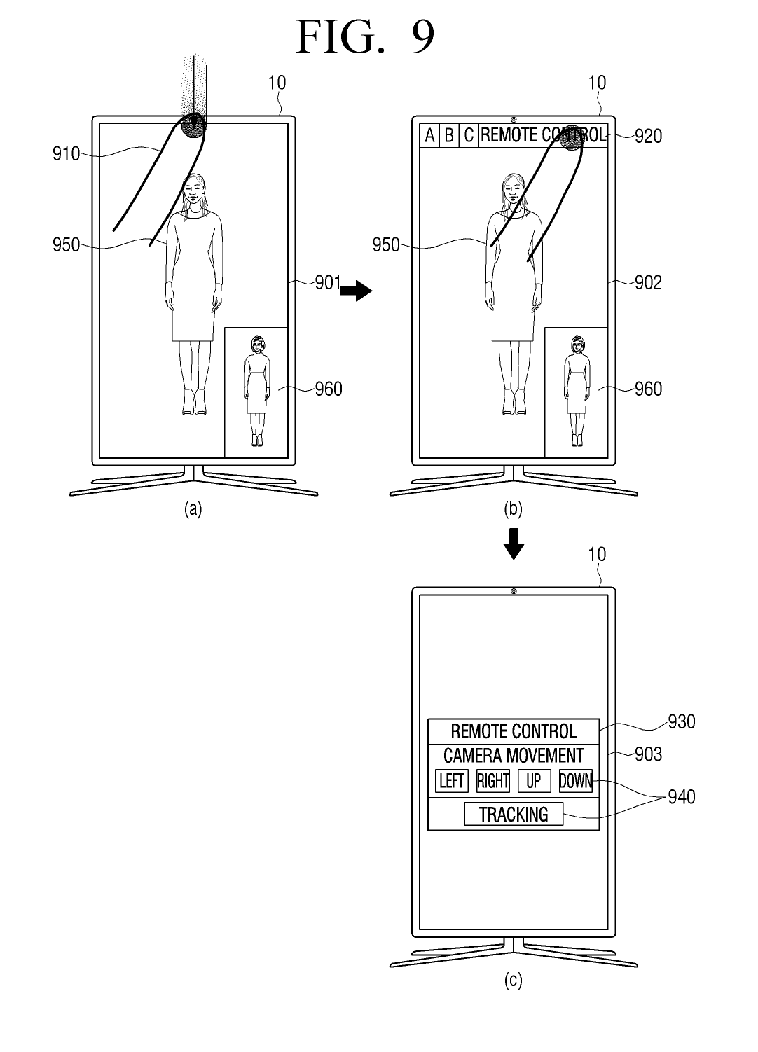

FIG. 9 is a view illustrating remotely controlling a photographing unit of the counterpart terminal 20 during a video call through the electronic apparatus 10, according to an exemplary embodiment of the present disclosure.

Referring to FIG. 9, a user 960 may touch 910 a display area 901 during a video call to select a command 920 for remotely controlling the photographing unit of the counterpart terminal 20. If the command 920 for the remote control is input into the electronic apparatus 10 by the user 960, the electronic apparatus 10 may wait until the counterpart terminal 20 responds to a request after the electronic apparatus 10 transmits a remote control request signal to the counterpart terminal 20.

Here, the electronic apparatus 10 may display a message (not shown) notifying that a remote control is being requested, in the display area 901. Also, the electronic apparatus 10 may receive a response signal for accepting a remote control request of the electronic apparatus 10 from the counterpart terminal 20. Here, the electronic apparatus 10 may display a message (not shown) notifying an approval of the remote control in a display area 902. Also, the electronic apparatus 10 may display remote control menus 930 and 940 in a display area 903.

For example, the electronic apparatus 10 may control the photographing unit of the counterpart terminal 20 in up, down, left, and right directions and to perform tracking and capturing 940. When the photographing unit of the counterpart terminal 20 is remotely controlled by the electronic apparatus 10, the counterpart terminal 20 captures a counterpart 950 according to a control command (up, down, left, and right capturing/tracking capturing) transmitted from the electronic apparatus 10. Therefore, the user 960 may receive an image of the counterpart 950, which is captured by a capturing method remotely controlled by the electronic apparatus 10, from the counterpart terminal 20.

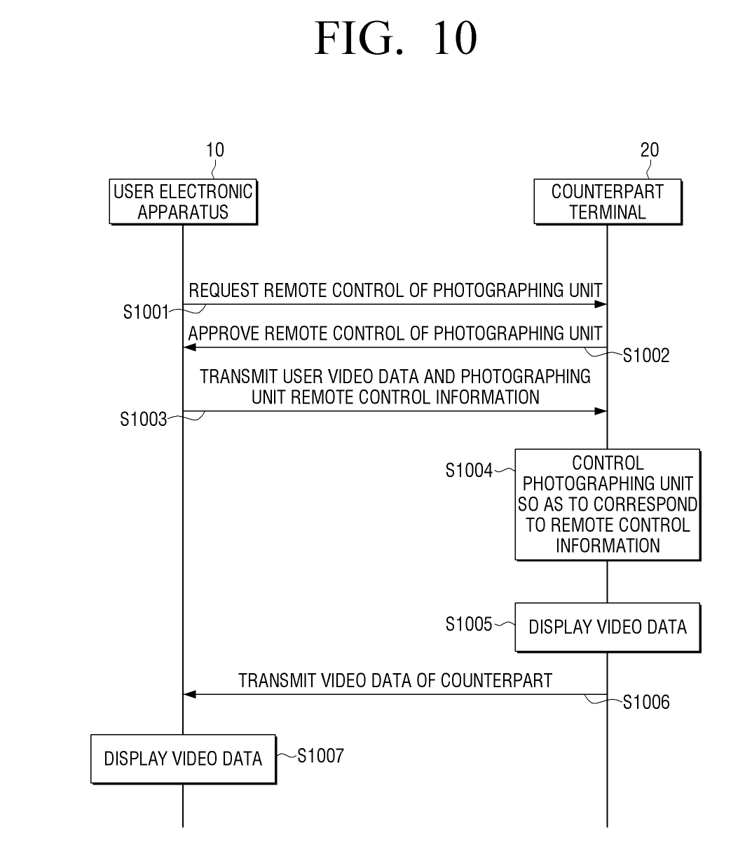

FIG. 10 is a sequence diagram illustrating remotely controlling the photographing unit of the counterpart terminal 20 during a video call through the electronic apparatus 10, according to an exemplary embodiment of the present disclosure.

Referring to FIG. 10, in operation S1001, the electronic apparatus 10 of a user transmits a request signal indicating that the user wants to remotely control the photographing unit of the counterpart terminal 20, to the counterpart terminal 20. In operation S1002, the counterpart terminal 20 transmits a remote control approval signal accepting a request of the electronic apparatus 10 to the electronic apparatus 10. In operation S1003, the electronic apparatus 10 transmits image data of the user captured by the electronic apparatus 10 and photographing unit remote control information of the counterpart terminal 20 to the counterpart terminal 20. In operation S1004, the counterpart terminal 20 may control the photographing unit of the counterpart terminal 20 to correspond to the remote control information received from the electronic apparatus 10 so as to capture a front person. In operation S1005, the counterpart terminal 20 displays the captured image data in a display of the counterpart terminal 20. In operation S1006, the counterpart terminal 20 transmits the captured image data to the electronic apparatus 10. In operation S1007, the electronic apparatus 10 displays an image of a counterpart, which is captured by a remote control and received from the counterpart terminal 20, in the display.

The photographing unit remote control information transmitted from the electronic apparatus 10 to the counterpart terminal 20 may be information that enables the photographing unit of the counterpart terminal 20 to be controlled on a screen of the electronic apparatus 10 in a video call mode according to a touch input method (e.g., left/right/up/down direction movements). Also, the remote control information may be tracking capturing information selected on the remote control command menu 940 by the electronic apparatus 10. When the electronic apparatus 10 selects a tracking capturing command, the counterpart terminal 20 may transmit an image, which is acquired by tracking and capturing a front counterpart performing capturing, to the electronic apparatus 10.

According to another exemplary embodiment, the remote control information may be zoom out/zoom in information. For example, when the electronic apparatus 10 zooms out/zooms in at least one of persons of an image, which is received from the counterpart terminal 20 and displayed on the screen of the electronic apparatus 10, with a finger, the counterpart terminal 20 may transmit an image, which is captured by zooming out/zooming in a selected person, to the electronic apparatus 10.

Here, zoom out/zoom in may be clicked and controlled through a finger or an input unit such as a stylus pen or the like. For example, when at least one person of the image, which is received from the counterpart terminal 20 and displayed on the electronic apparatus 10, is double clicked with a stylus pen, the electronic apparatus 10 may request the counterpart terminal 20 to zoom out and capture the selected person. Also, when at least one person of the image, which is received from the counterpart terminal 20 and displayed on the electronic apparatus 10, is one clicked or circled with a stylus pen, the electronic apparatus 10 may request the counterpart terminal 20 to zoom in and capture the selected person. The counterpart terminal 20 may zoom out and capture the selected person, and transmit the captured person to the electronic apparatus 10 according to a remote control request received from the electronic apparatus 10.

However, a remote control command through the above-described touch input and an input of an input unit is merely an exemplary embodiment for describing the present disclosure but are not limited thereto. Therefore, the remote control command may be realized as various methods (e.g., a manipulation using a remote controller, a manipulation through a voice recognition, and the like).

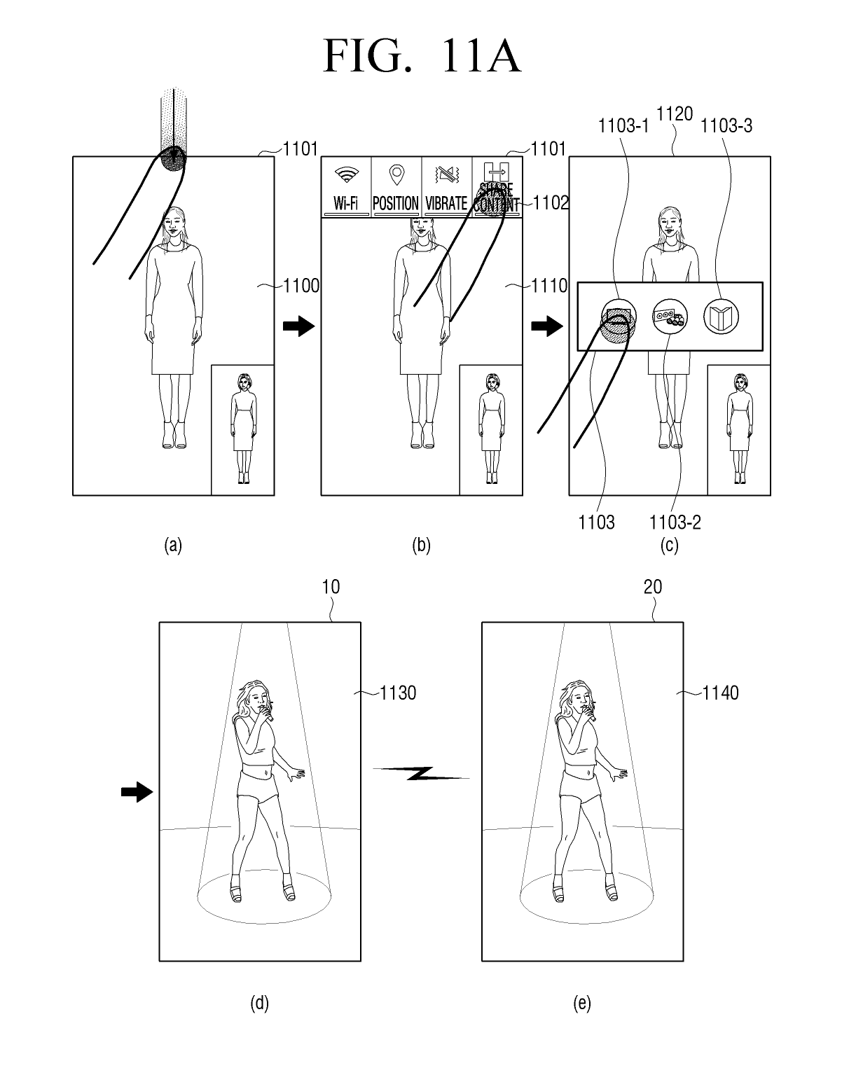

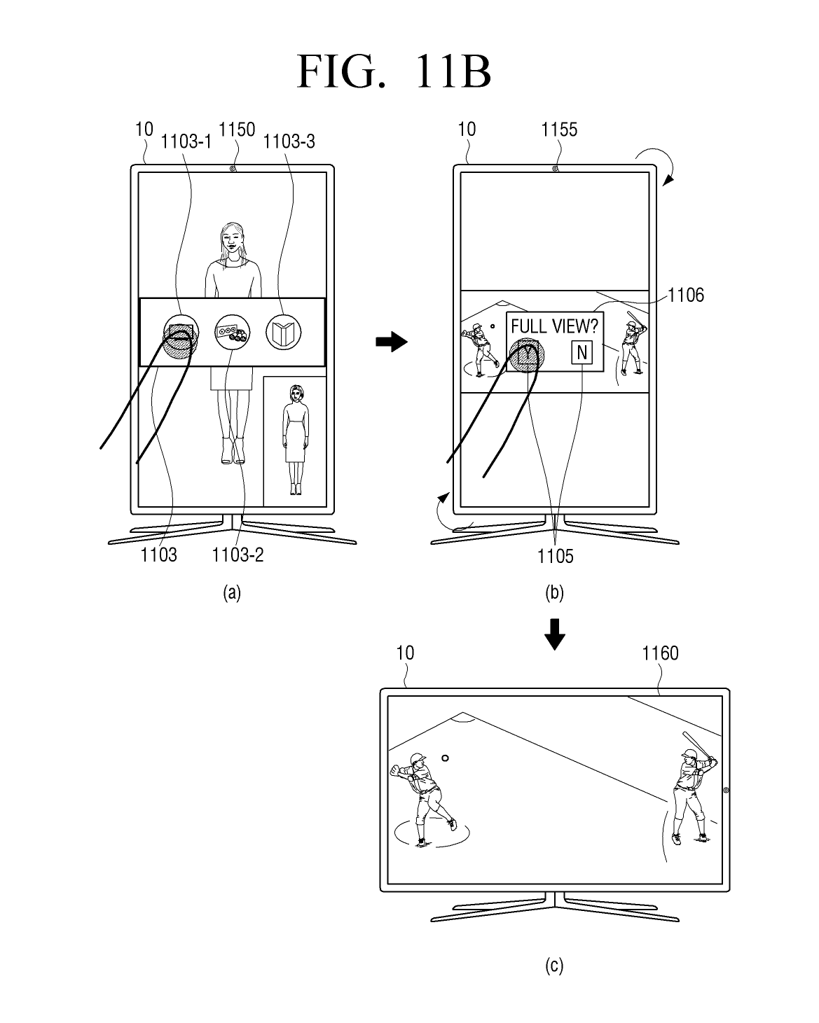

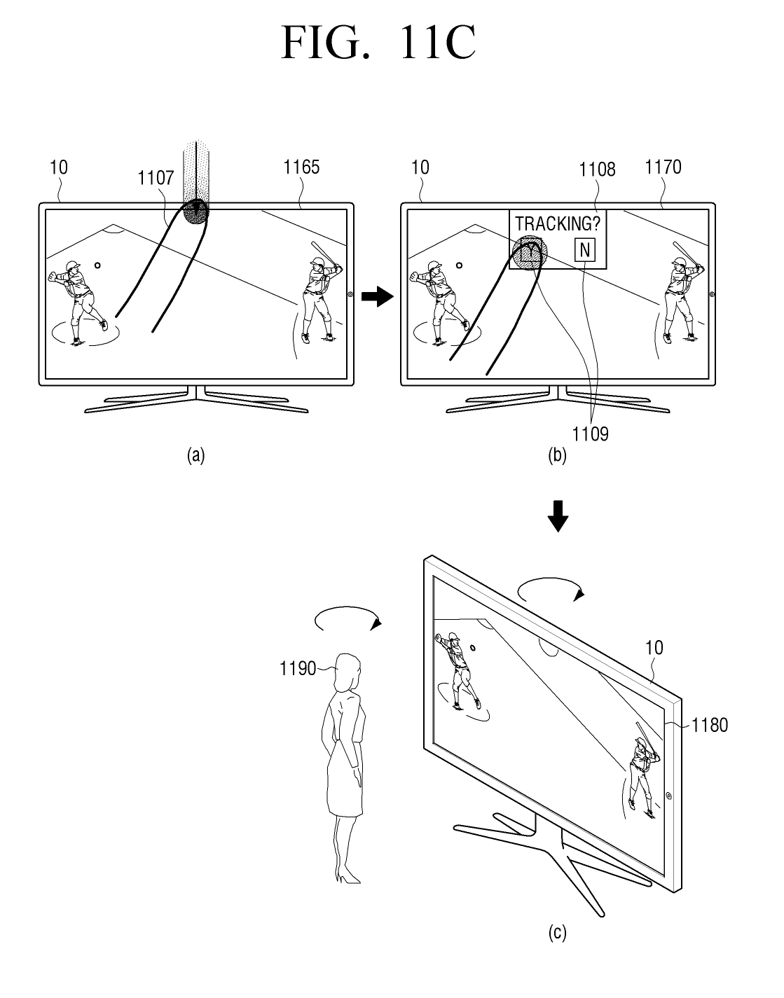

FIGS. 11A through 11C are views illustrating the electronic apparatus 10 sharing a content of a user with the counterpart terminal 20 during a video call, according to an exemplary embodiment of the present disclosure.

Referring to FIG. 11A, the electronic apparatus 10 may share a content stored in the electronic apparatus 10 with the counterpart terminal 20.

For example, the content may be audio, video, a text, an image, or the like. Alternatively, the content may be a link address (e.g., a uniform resource locator (URL)) designating a position where the content is stored. For example, the content may be an audio link address, a video link address, a text link address, an image link address, or the like. Alternatively, the content may be a thumbnail of the content.

For example, the content may be a video thumbnail, a text thumbnail, an image thumbnail, or the like. Alternatively, the content may be constituted by combining two or more of types of the above-described contents. For example, the content may include both of video and a video thumbnail. As another example, the content may include both of a video thumbnail and a video link address.

For convenience of description, an operation of the electronic apparatus 10 will be described for a multimedia image stored in the electronic apparatus 10 with reference to FIG. 11A.

The electronic apparatus 10 displays a select menu 1101 in a display area 1100 to share an image content stored in the electronic apparatus 10 with the counterpart terminal 20 during a video call. If a user touches and drags or touches the select menu 1101 of the electronic apparatus 10, a content share menu 1102 is displayed in a display area 1110. When the user selects the content share menu 1102 of the electronic apparatus 10, the electronic apparatus 10 displays menus 1103-1, 1103-2, and 1103-3, which are classified according to types of contents stored in the electronic apparatus 10, in a display area 1120.

According to an exemplary embodiment of the present disclosure, if a content list (not shown) is displayed in a display area of the electronic apparatus 10 when the user shares and selects a multimedia image 1103-1 among the contents stored in the electronic apparatus 10, the electronic apparatus 10 may select at least one content (not shown) from the content list (not shown).

The electronic apparatus 10 may play the selected content in a display area 1130. Here, the electronic apparatus 10 may transmit a content share request message for sharing the selected content to the counterpart terminal 20. The counterpart terminal 20 receives the content share request message of the electronic apparatus 10 so as to transmit a response message for determining whether the electronic apparatus 10 is provided with a content set to be shared, to the electronic apparatus 10. If the counterpart terminal 20 responds to the content share request of the electronic apparatus 10, a base station or a sever that manages a video call of the electronic apparatus 10 and the counterpart terminal 20 provides the counterpart terminal 20 with a content selected by the electronic apparatus 10. The counterpart terminal 20 may play an image screen, which is received from the base station or the server, in a display area 1140 of the counterpart terminal 20.

According to another exemplary embodiment, the electronic apparatus 10 may transmit information including a video link address to the counterpart terminal 20.

If information including a content is transmitted to the counterpart terminal 20, the counterpart terminal 20 may play a content based on the content. For example, if the received content is a video link address, the counterpart terminal 20 may acquire video indicated by the video link address by accessing a server (not shown) and play the acquired video.

FIG. 11B is a view illustrating a display that automatically rotates on a full screen according to a screen ratio of a played content when sharing a video content with the counterpart terminal 20 during a video call.

Referring to FIG. 11B, as described above with reference to FIG. 11A, the user may select video contents 1103-1, 1103-2, and 1103-3, which will be shared with the counterpart terminal 20, through a menu 1103 in a video call mode.

For example, when a video content selected by the user is a baseball game played in a horizontal direction in a display area 1155, the electronic apparatus 10 has a remaining space where the baseball game is not played in the display area 1155. Here, the electronic apparatus 10 may display a message 1106 for determining a screen ratio of a played video content to question the user about whether to set a full view, in the display area 1155.

Here, when the user selects the full view Y 1105, the electronic apparatus 10 may automatically rotate a display according to the screen ratio (e.g., 4:3, 16:9, or the like) of the played video content to play the video content on a full screen 1160.

FIG. 11C is a view illustrating the electronic apparatus 10 that tracks a position of a user, rotates a display, and plays a video content when the electronic apparatus 10 shares a video image content with the counterpart terminal 20 during a video call.

Referring to FIG. 11C, the user may touch a screen, on which the user is watching a video, to select an automatic tracking function command 1108. If the user touches and drags 1107 the screen or touches (not shown) the screen, the electronic apparatus 10 may display a message 1108, which questions the user about whether the screen tracks the user and rotates, in a display area 1170. When a user 1190 selects an automatic tracking function Yes 1109, a screen 1180 of the electronic apparatus 10 may rotate according to a position of a user, who is watching a video of the electronic apparatus 10 in a video call mode, to display a video content that is being played.

A user command input method by touch and drag described in the present disclosure is merely an exemplary embodiment for describing the present disclosure and is not limited thereto. Therefore, the user command input method may be realized as various types of methods such as a voice recognition, a sensor recognition, and the like.

Also, for convenience of description in the present disclosure, when a screen of the electronic apparatus 10 is in a vertical direction of 3:4, and a video that is being played is in a horizontal direction of 4:3, the electronic apparatus 10 may rotate the screen in the horizontal direction of 4:3 according to a screen ratio of 4:3 of the video that is being played to play the video on a full screen.

In the present disclosure, when the screen of the electronic apparatus 10 is in a horizontal direction of 4:3, and the video that is being played is in a vertical direction of 3:4, the electronic apparatus 10 may rotate the screen in the vertical direction of 3:4 according to the screen ratio of 3:4 of the video that is being played, to play the video on a full screen. Also, a screen ratio of the screen is merely an exemplary embodiment for describing the present disclosure and is not limited thereto. Therefore, the screen may be realized as screens having various sizes.

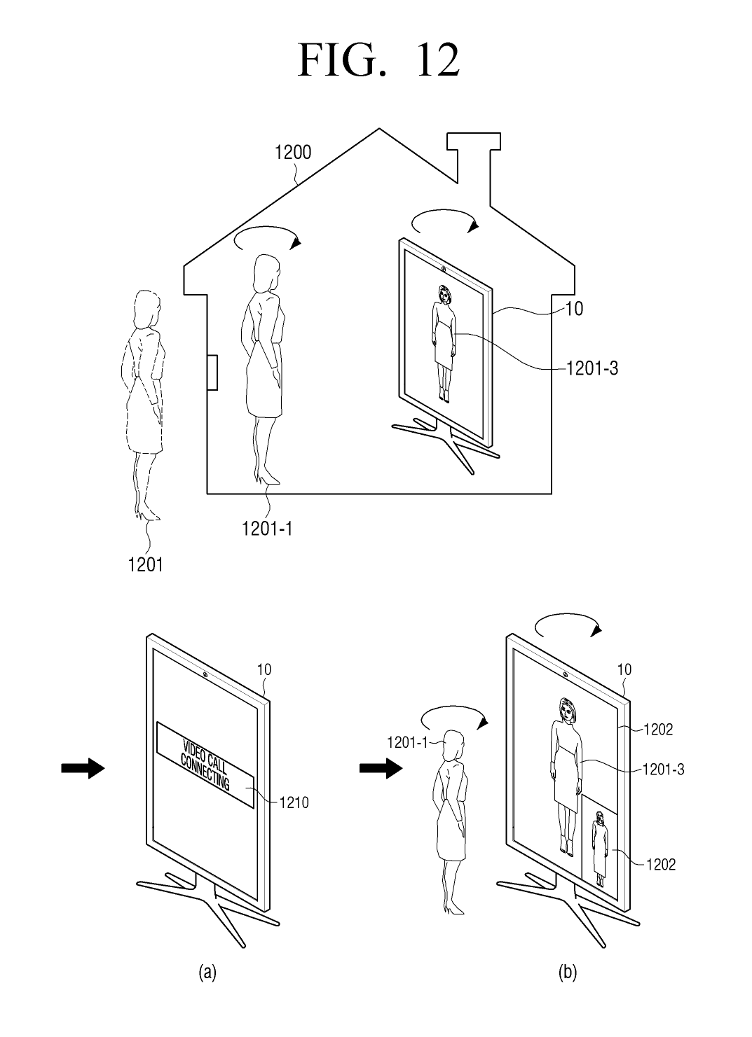

FIG. 12 is a view illustrating a video call for automatically performing tracking and capturing through a sensor on a home network, according to another exemplary embodiment of the present disclosure.

Referring to FIG. 12, the electronic apparatus 10 senses a position movement of a user by using sensors respectively positioned in several places (e.g., a front door, a kitchen, a living room, and the like) of a home 1200 in a home network and provides the electronic apparatus 10 with a video call function in a corresponding area where the user is positioned.

For example, when a user 1201 enters into the front door where the home network is installed, a sensor positioned at the front door may automatically recognize a user 1201-1. The sensor positioned at the front door may transmit information indicating that the user 1201-1 enters into the home 1200, to the electronic apparatus 10 positioned closest to the user 1201-1. When the user 1201-1 enters into a capturing range of the electronic apparatus 10, the electronic apparatus 10 may automatically display a user 1201-3 on the electronic apparatus 10 based on information of the user 1201-1 received from the sensor positioned at the front door. Also, the electronic apparatus 10 may automatically execute a video call connection to the counterpart 20 designated in the electronic apparatus 10.

Here, the electronic apparatus 10 may display a message 1210 notifying that the video call connection to the counterpart terminal 20 is being performed, in a display area. The electronic apparatus 10 may output a message displayed in a display area as a voice. Also, if a video call is connected to the counterpart terminal 20, the electronic apparatus 10 may automatically track and capture according to a position movement of the user 1201-1 or may select automatic tracking and capturing according to an input command of a user. Tracking and capturing of the electronic apparatus 10 are the same as the contents described above with reference to FIGS. 1 through 12, and thus their detailed descriptions are omitted.

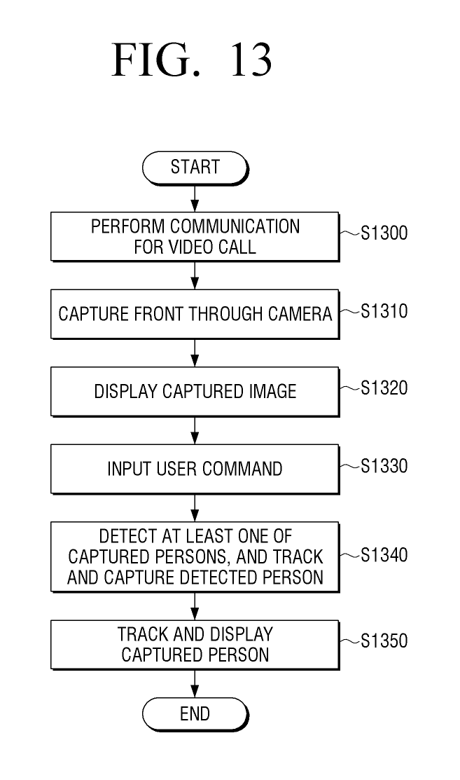

FIG. 13 is a flowchart of a method of performing tracking and capturing during a video call, according to an exemplary embodiment of the present disclosure.

Referring to FIG. 13, in operation S1300, the electronic apparatus 10 performs communication for a video call with the counterpart terminal 20. Here, if at least one person included in an image received from the counterpart terminal 20 is selected, the electronic apparatus 10 may request a photographing unit of the counterpart terminal 20 to track the selected person and receive a response message responding to the request. Also, the electronic apparatus 10 may transmit a request message to the counterpart terminal 20 so as to remotely control the photographing unit of the counterpart terminal 20 and receive a response message responding to the request message. Also, when a name of at least one person included in the image received from the counterpart terminal 20 is uttered, the electronic apparatus 10 may request the photographing unit of the counterpart terminal 20 to track the uttered person and receive a response message responding to the request. The electronic apparatus 10 may transmit a message, which requests a content stored in the electronic apparatus 10 to be shared, to the counterpart terminal 20 and receive a response message responding to the request.

The electronic apparatus 10 captures a front through a camera installed in the electronic apparatus 10 in operation S1310 and displays the captured image in a display area of the electronic apparatus 10 in operation S1320. Here, the electronic apparatus 10 may display the image received from the counterpart terminal 10 together in the display area.

In a video call mode, a designated user command is input in operation S1330, and the electronic apparatus 10 may detect at least one captured person, and track and capture the detected person in operation S1340.

Here, the electronic apparatus 10 may detect a person closest to the electronic apparatus 10 among at least one person included in a captured image. Also, the electronic apparatus 10 may track and capture the detected closest person.

If the detected person strays from a designated capturing range, the electronic apparatus 10 may pause tracking and capturing the detected person. Also, if the detected person strays from the designated capturing range for a designated time, the electronic apparatus 10 may return to an initial capturing position to capture a front.

The electronic apparatus 10 may be realized to recognize a voice and a motion of a user who indicates a particular direction so as to rotate and capture in a direction indicated by the user. Also, if it is detected that the user strays from a capturing range of the electronic apparatus 10 and enters into a capturing range of the peripheral terminal apparatus 10-1 when the peripheral terminal apparatus 10-1 that is communicating with the electronic apparatus 10 is searched, the electronic apparatus 10 may transmit video call change information to the peripheral terminal apparatus 10-1. Here, the connected peripheral terminal apparatus 10-1 may continuously perform a video call by tracking and capturing the user.

When the user utters a name of at least one person included in an image transmitted from the counterpart terminal 20, the electronic apparatus 10 may be realized to recognize a voice of the user, who utters the name of the at least one person, so as to track and capture the user.

In operation S1350, the electronic apparatus 10 may track the captured person and display the tracked person in the display area. Also, when a full view mode of a video content that is being played is selected during a video call by a user input, the electronic apparatus 10 may automatically rotate a screen according to a screen ratio of the video content that is being played so as to display an image. Here, when an automatic tracking mode is selected by a user input, the electronic apparatus 10 may display a content, which is being played, by tracking a position of the user and rotating the screen.

An apparatus (e.g., modules or the electronic apparatus 10) or a method (e.g., operations) according to various exemplary embodiments may be executed, for example, by at least one computer (e.g., the processor 140) that executes an instruction included in at least one program of programs maintained on computer-readable storage media.

If the instruction is executed by a computer (e.g., the processor 140 or 180), the at least one computer may perform a function corresponding to the instruction. Here, a computer-readable storage medium may, for example, be the memory 150.

A program may be included in a computer-readable storage medium such as a hard disc, a floppy disc, a magnetic medium (e.g., a magnetic tape), an optical medium (e.g., a compact disc read only memory (CD-ROM)), a digital versatile disc (DVD), a magneto-optical medium (e.g., a floptical disc), a hardware device (e.g., a read only memory (ROM), a random access memory (RAM), a flash memory, or the like), or the like. In this case, a storage medium is generally included as a part of elements of the electronic apparatus 10 but may be installed through a port of the electronic apparatus 10 or may be included in an external device (e.g., cloud, a server, or another electronic device) positioned outside the electronic apparatus 10. Also, the program may be divided and stored on a plurality of storage media. Here, at least some of the plurality of storage media may be positioned in an external device of the electronic apparatus 10.

An instruction may include a machine language code that is made by a compiler and a high-level language code that may be executed by a computer by using an interpreter or the like. The hardware device described above may be constituted to operate as one or more software modules in order to perform operations of various exemplary embodiments, but an opposite case is similar.

The foregoing exemplary embodiments and advantages are merely exemplary and are not to be construed as limiting the present disclosure. The present teaching may be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. An electronic apparatus providing a video call, the electronic apparatus comprising:
a communicator configured to perform a video call;
a photographing unit configured to capture a front;
a display configured to display an image captured by the photographing unit; and
a processor configured to, in response to a designated user command being input while performing a video call, detect at least one person included in the image captured by the photographing unit, control the photographing unit to track and capture the detected person, and control the display to track and display the detected person.

2. The electronic apparatus of claim 1, wherein the processor detects a person closest to the electronic apparatus among the at least one person included in the image captured by the photographing unit and controls the photographing unit to track and capture the closest person.

3. The electronic apparatus of claim 2, wherein the processor controls the photographing unit to pause the tracking in response to the detected person straying from a designated capturing range and return to an initial capturing position in response to the detected person straying from the designated capturing range for a designated time.

4. The electronic apparatus of claim 1, wherein in response to a voice or a motion of a user, who indicates a particular direction, being input during the video call, the processor controls the photographing unit to rotate in the particular direction.

5. The electronic apparatus of claim 1, wherein the communicator performs communication with at least one peripheral terminal apparatus while performing the video call,
wherein in response to a person being detected by the peripheral terminal apparatus as straying from a capturing range of the electronic apparatus and entering into a capturing range of the peripheral terminal apparatus, the processor receives an event signal indicating that the person is detected, from the peripheral terminal apparatus and controls the communicator to transmit image data received from an counterpart terminal while performing the video call, to the peripheral terminal apparatus in response to the event signal.

6. The electronic apparatus of claim 1, wherein the processor controls the display to display an image received from an counterpart terminal while performing a video call and, in response to one of at least one person included in an image received from the counterpart terminal, controls the communicator to transmit a signal requesting a photographing unit of the counterpart terminal to track the selected person to the counterpart terminal.

7. The electronic apparatus of claim 1, wherein the processor controls the display to display an image received an counterpart terminal while performing a video call, in response to a user command for entering into a mode for remotely controlling the counterpart terminal, being input, controls the communicator to transmit a remote control request signal to the counterpart terminal, and in response to a remote control acceptance signal being received from the counterpart terminal in response to the remote control request signal, controls the display to display a User Interface (UI) for controlling the counterpart terminal.

8. The electronic apparatus of claim 1, wherein the processor controls the display to display an image received from an counterpart terminal while performing a video call and, in response to a name of one of at least one person included in the image received from the counterpart terminal being uttered by a user, controls the communicator to transmit a signal which requests a photographing unit of the counterpart terminal to track the uttered person, and utterance information to the counterpart terminal.

9. The electronic apparatus of claim 1, wherein the processor controls the photographing unit to recognize a voice of the user who performs the uttering so as to track and capture the user.

10. The electronic apparatus of claim 1, wherein:
in response to a user command for entering into a content share mode being input, the communicator performs communication so as to share a video content with an counterpart terminal while performing the video call; and
in response to a user command for a full screen view being input, the processor controls the display to automatically display a full screen according to a screen ratio at which the video content is played and, in response to the designated user command being input, controls the display to automatically rotate and display the video content according to a position of the user.

11. A video call method comprising:
performing communication for a video call;
capturing a front through a camera;
displaying the captured image;
in response to a designated user command being input while performing a video call, detecting at least one person included in the captured image, and tracking and capturing the detected person; and
tracking and displaying the detected person.

12. The video call method of claim 11, wherein the tracking and capturing comprises detecting a person closest to the camera among the at least one person included in the image captured by the camera, and tracking and capturing the closest person.

13. The video call method of claim 12, wherein the tracking and capturing comprises pausing the tracking in response to the detected person straying from a designated capturing range and enabling the camera to return to an initial capturing position in response to the detected person straying from the designated capturing range for a designated time.

14. The video call method of claim 11, wherein the tracking and capturing comprises, in response to a voice or a motion of the user who indicates a particular direction being input during the video call, rotating the camera in the particular direction and then performing capturing.

15. The video call method of claim 11, wherein:
the performing of the communication comprises performing communication with at least one peripheral terminal apparatus while performing the video call; and
the tracking and capturing comprises, in response to a person being detected by the peripheral terminal apparatus as straying from a capturing range of the electronic apparatus and entering into a capturing range of the peripheral terminal apparatus, receiving an event signal indicating that the person is detected, from the peripheral terminal apparatus and transmitting video data received from the counterpart terminal while performing the video call, to the peripheral terminal apparatus in response to the event signal.

16. The video call method of claim 11, wherein the displaying comprises displaying an image received from a counterpart terminal while performing a video call,
wherein the tracking and capturing comprises, in response to one of at least one person included in the image received from the counterpart terminal, transmitting a signal which requests a camera of the counterpart terminal to track the selected person to the counterpart terminal.

17. The video call method of claim 11, wherein the tracking and capturing comprises, in response to a user command for entering into a mode for remotely controlling the counterpart terminal, transmitting a remote control request signal to the counterpart terminal,
wherein the displaying comprises displaying an image received from a counterpart terminal while performing a video call and, in response to a remote control acceptance signal being received from the counterpart terminal in response to the remote control request signal, displaying an UI for controlling the counterpart terminal.

18. The video call method of claim 11, wherein the displaying comprises displaying an image received from a counterpart terminal while performing a video call,
wherein the tracking and capturing comprises, in response to a name of one of at least one person included in an image received from the counterpart terminal being uttered by the user, enabling a camera of the counterpart terminal to track and capture the uttered person.

19. The video call method of claim 11, wherein the tracking and capturing comprises enabling the camera to recognize a voice of the uttered user so as to track and capture the user.

20. The video call method of claim 11, wherein the performing of the communication comprises, in response to a user command for entering into a content share mode being input, performing communication so as to enable a user to share a video content with a counterpart terminal while performing the video call,
wherein the tracking and displaying comprises, in response to a user command for a full screen view being input, automatically displaying the video content on a full screen according to a screen ratio at which the video content is played and, in response to the designated user command being input, automatically rotating and displaying the video call according to a position of the user.
